(19) United States
(12) Patent Application Publication
(10) Pub. No.: US 2020/0310302 A1
(43) Pub. Date: Oct. 1, 2020

(54) IMAGE FORMING APPARATUS AND PROCESS CARTRIDGE INCLUDING A PHOTORECEPTOR HAVING POLYTETRAFLOUROETHYLENE PARTICLES

(71) Applicant: FUJI XEROX Co., Ltd., Tokyo (JP)

(72) Inventors: Tomoko SUZUKI, Kanagawa (JP); Wataru YAMADA, Kanagawa (JP)

(73) Assignee: FUJI XEROX Co., Ltd., Tokyo (JP)

(21) Appl. No.: 16/531,354

(22) Filed: Aug. 5, 2019

(30) Foreign Application Priority Data
Mar. 25, 2019 (JP) 2019-057078

(51) Int. Cl. G03G 15/16; G03G 21/00; G03G 5/05; G03G 5/043

(52) U.S. Cl. CPC G03G 15/162; G03G 5/043; G03G 5/0539; G03G 21/0017

(57) ABSTRACT

An image forming apparatus includes a photoreceptor photoreceptor having an outermost surface layer that contains polytetrafluoroethylene particles and a dispersant containing fluorine atoms and has a perfluorooctanoic acid content of 25 ppb or less relative to the polytetrafluoroethylene particles; and a transfer device that includes an intermediate transfer body having a surface onto which a toner image is transferred, a first transfer device that performs first transfer that involves transferring the toner image on the surface of the photoreceptor onto the surface of the intermediate transfer body, and a second transfer device that performs second transfer that involves transferring the toner image on the surface of the intermediate transfer body onto a surface of a recording medium, the second transfer device having a second transfer member having a surface with a hexadecane contact angle of 30 degrees or more.

### CROSS-REFERENCE TO RELATED APPLICATIONS

This application is based on and claims priority under 35 USC 119 from Japanese Patent Application No. 2019-057078 filed Mar. 25, 2019.

### BACKGROUND

### (i) Technical Field

The present disclosure relates to an image forming apparatus and a process cartridge.

### (ii) Related Art

Japanese Unexamined Patent Application Publication No. 2015-018227 discloses an electrophotographic member having a substrate and a surface layer, the surface layer containing a binder resin having an acryl skeleton and a modified silicone compound having a polyether group and a hydroxyl group in one molecule, the surface layer having a surface having an n-hexadecane contact angle of 30° or more.

Japanese Unexamined Patent Application Publication No. 2017-090566 discloses an “electrophotographic photoreceptor that includes a photosensitive layer containing a surfactant and a binder resin, in which the surfactant content relative to 100.00 parts by mass of the binder resin is 0.10 parts by mass or more and 3.00 parts by mass or less, the hydrophobic group in the surfactant is a perfluoroalkyl group, and the surfactant is nonionic”.

Japanese Unexamined Patent Application Publication No. 2010-181718 discloses an “image forming mechanism that includes an image carrier that includes a photosensitive layer on which an electrostatic latent image is to be formed, the photosensitive layer constituting a surface of the image carrier and containing a lubricant; a developing unit that develops the electrostatic latent image into a visible image by using a developer that contains the lubricant; and a cleaning member that includes a first layer that contacts the photosensitive layer and a second layer that does not contact the surface of the image carrier, is composed of a material having a smaller rebound resilience than the first layer, and is stacked on the first layer”.

### SUMMARY

Aspects of non-limiting embodiments of the present disclosure relate to an image forming apparatus having an excellent second transfer member cleanability maintaining property compared to an image forming apparatus including a toner image forming device that includes a photoreceptor and forms a toner image on a surface of the photoreceptor, the photoreceptor having an outermost surface layer that contains polytetrafluoroethylene particles (hereinafter may also be referred to as the “PTFE particles”) and a dispersant containing fluorine atoms (hereinafter may also be referred to as the “fluorine-containing dispersant”) and has a perfluorooctanoic acid (hereinafter may also be referred to as the “PFOA”) content of 25 ppb or less relative to the polytetrafluoroethylene particles; and a transfer device that includes an intermediate transfer body having a surface onto which the toner image is transferred, a first transfer device that performs first transfer that involves transferring the toner image on the surface of the photoreceptor onto the surface of the intermediate transfer body, and a second transfer device that performs second transfer that involves transferring the toner image on the surface of the intermediate transfer body onto a surface of a recording medium, the second transfer device having a second transfer member having a surface with a hexadecane contact angle of less than 30 degrees.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including a toner image forming device that includes a photoreceptor and forms a toner image on a surface of the photoreceptor, the photoreceptor having an outermost surface layer that contains polytetrafluoroethylene particles and a dispersant containing fluorine atoms and has a perfluorooctanoic acid content of 25 ppb or less relative to the polytetrafluoroethylene particles; and a transfer device that includes an intermediate transfer body having a surface onto which the toner image is transferred, a first transfer device that performs first transfer that involves transferring the toner image on the surface of the photoreceptor onto the surface of the intermediate transfer body, and a second transfer device that performs second transfer that involves transferring the toner image on the surface of the intermediate transfer body onto a surface of a recording medium, the second transfer device having a second transfer member having a surface with a hexadecane contact angle of 30 degrees or more.

### BRIEF DESCRIPTION OF THE DRAWINGS

Exemplary embodiments of the present disclosure will be described in detail based on the following figures, wherein:

FIG. 1 is a schematic diagram illustrating one example of an image forming apparatus according to an exemplary embodiment;

FIG. 2 is a schematic diagram illustrating a second transfer unit and a periphery thereof according to another example of the image forming apparatus according to the exemplary embodiment; and

FIG. 3 is a schematic cross-sectional view of one example of the layer structure of an electrophotographic photoreceptor of an exemplary embodiment.

### DETAILED DESCRIPTION

An exemplary embodiment, which is one example of the present disclosure, will now be described in detail.

An image forming apparatus of this exemplary embodiment includes a toner image forming device that includes a photoreceptor and forms a toner image on a surface of the photoreceptor, the photoreceptor having an outermost surface layer that contains polytetrafluoroethylene particles (PTFE particles) and a dispersant containing fluorine atoms (fluorine-containing dispersant) and has a perfluorooctanoic acid (PFOA) content of 25 ppb or less relative to the polytetrafluoroethylene particles; and a transfer device that includes an intermediate transfer body having a surface onto which the toner image is transferred, a first transfer device that performs first transfer that involves transferring the toner image on the surface of the photoreceptor onto the surface of the intermediate transfer body, and a second transfer device that performs second transfer that involves transferring the toner image on the surface of the intermediate transfer body onto a surface of a recording medium, the second transfer device having a second transfer member having a surface with a hexadecane contact angle of 30 degrees or more.

Adding PTFE particles to the outermost surface layer of the photoreceptor to improve the cleanability is known.

Meanwhile, the PTFE particles added in the surface of the photoreceptor migrate to the surface of the second transfer member via the intermediate transfer body. Since the PTFE particles have spreadability, the PTFE particles spread to form a film on a surface of the second transfer member when stress is applied by the cleaning member.

However, when the PTFE particle in the outermost surface layer of the photoreceptor is poorly dispersed, the PTFE particles sparsely migrate to the surface of the second transfer member. Thus, the PTFE particles spread to form a film on some parts of the surface of the second transfer member. Accordingly, cleaning failure occurs on the surface of the second transfer member over time, and streak-like image defects may occur. In addition, when the cleaning member is a blade, turning-up of the blade may occur. As such, the cleanability maintaining property may be degraded.

In contrast, the image forming apparatus of the exemplary embodiment having the aforementioned features has an excellent second transfer member cleanability maintaining property. The reason behind this is presumably as follows.

Typically, PTFE particles are mixed with a fluorine-containing dispersant together with, for example, components such as a dispersing medium and powder. However, when the state of the components mixed together changes (for example, changes such as evaporation of the dispersion medium and melting of the powder), the dispersibility of the polytetrafluoroethylene particles tends to be degraded.

Specifically, for example, when a layer-shaped article containing PTFE particles is to be formed by using a liquid composition (for example, a layer-forming coating solution or the like) containing PTFE particles, a fluorine-containing dispersant, a resin, and a dispersion medium, the dispersion medium is dried during the process of forming the layer-shaped article. During the process of drying (in other words, evaporating) the dispersion medium, the dispersibility of the PTFE particles may become degraded, and agglomeration of the PTFE particles may occur.

As a result, a layer-shaped article containing poorly dispersed PTFE particles is formed. The cause of this is as follows.

The PTFE particles often contain PFOA since PFOA is used or occurs as a by-product during the process of producing the PTFE particles.

When PFOA is present, the PTFE particles contained in the composition are highly dispersed due to the fluorine-containing dispersant. However, when the state of the components mixed together changes, the state of the fluorine-containing dispersant attaching to the PTFE particles changes. In particular, some of the fluorine-containing dispersant presumably detaches from the PTFE particles due to PFOA. Thus, the dispersibility of the PTFE particles is degraded, and agglomeration of the PTFE particles occurs.

Thus, in a liquid composition containing PTFE particles and a fluorine-containing dispersant, the PFOA content relative to the PTFE particles is set to 25 ppb or less. In other words, the PFOA content is zero or small if any. In this manner, the “change in the state of the fluorine-containing dispersant attaching to the PTFE particles” that occurs due to PFOA when the state of the components mixed together changes is suppressed.

Thus, a layer-shaped article formed by using this liquid composition contains highly dispersed PTFE particles. In other words, in the photoreceptor that has the outermost surface layer formed of this layer-shaped article, the PTFE particles in the outermost surface layer is in a highly dispersed state.

Meanwhile, the hexadecane contact angle at the surface of the second transfer member is set to 30 degrees or more so that the affinity to the PTFE particles is high. As a result, the surface of the second transfer member is in a state that allows the PTFE particles to actively and easily adhere and spread thereto.

Thus, the PTFE particles actively migrate to the entire surface of the second transfer member from the outermost surface layer of the photoreceptor in a substantially uniform manner, and spread to form a film on the entire surface. As a result, the cleaning failure (specifically, streak-like image defects) of the surface of the second transfer member over time is suppressed. In addition, when the cleaning member is a blade, turning-up of the blade is suppressed.

In view of the above, it is presumed that the image forming apparatus of the exemplary embodiment exhibits an excellent second transfer member cleanability maintaining property.

An example of the toner image forming device of the image forming apparatus of the exemplary embodiment is a device equipped with a photoreceptor, a charging device that charges a surface of the photoreceptor, an electrostatic latent image forming device that forms an electrostatic latent image on the charged surface of the photoreceptor, and a developing device that develops the electrostatic latent image on the surface of the photoreceptor by using a developer containing a toner so as to form a toner image.

Alternatively, the transfer device may be a device that transfers a toner image onto a surface of a recording medium via more than one intermediate transfer body. In other words, the transfer device may be a device that performs first transfer of the toner image from the photoreceptor to a first intermediate transfer body, second transfer of the toner image from the first intermediate transfer body to a second intermediate transfer body, and then third transfer of the toner image from the second intermediate transfer body to a recording medium.

The image forming apparatus of the exemplary embodiment is applied to a known image forming apparatus, examples of which include an apparatus equipped with a fixing unit that fixes the toner image transferred onto the surface of the recording medium; an apparatus equipped with a cleaning unit that cleans the surface of the electrophotographic photoreceptor after the toner image transfer and before charging; an apparatus equipped with a charge erasing unit that erases the charges by irradiating the surface of the electrophotographic photoreceptor with charge erasing light after the toner image transfer and before charging; and an apparatus equipped with an electrophotographic photoreceptor heating member that elevates the temperature of the electrophotographic photoreceptor to reduce the relative temperature.

The image forming apparatus of this exemplary embodiment may be of a dry development type or a wet development type (development type that uses a liquid developer).

In the image forming apparatus of the exemplary embodiment, for example, a section that includes the electrophotographic photoreceptor may be configured as a cartridge structure (process cartridge) detachably attachable to the image forming apparatus. A process cartridge equipped with a toner image forming device and a transfer device may be used as the process cartridge, for example.

One example of the image forming apparatus of this exemplary embodiment will now be described with reference to the drawings. The description below do not limit the image forming apparatus of this exemplary embodiment. Only relevant sections illustrated in the drawings are described, and descriptions of other sections are omitted.

### Image Forming Apparatus

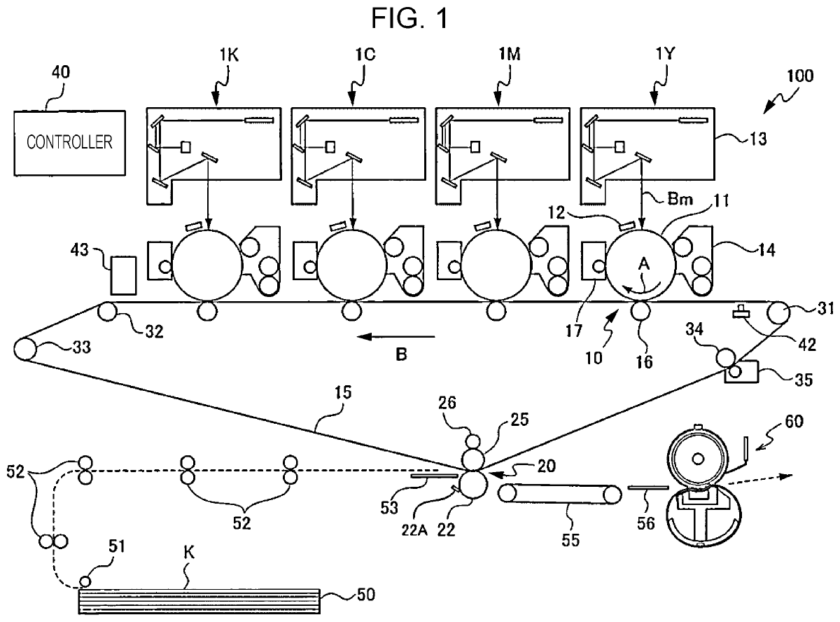

FIG. 1 is a schematic diagram illustrating a structure of an image forming apparatus according to this exemplary embodiment.

As illustrated in FIG. 1, an image forming apparatus 100 is, for example, an intermediate transfer-type image forming apparatus generally known as a tandem type. The image forming apparatus 100 includes image forming units 1Y, 1M, 1C, and 1K that electrophotographically form toner images of respective color components (one example of the toner image forming device); a first transfer unit 10 that sequentially transfers, onto an intermediate transfer belt 15, the toner images of the respective color components formed by the image forming units 1Y, 1M, 1C, and 1K (first transfer); a second transfer unit 20 that simultaneously transfers the superimposed toner images on the intermediate transfer belt 15 onto a sheet K serving as a recording medium (second transfer); and a fixing device 60 that fixes the second-transferred image to the sheet K. The image forming apparatus 100 also includes a controller 40 that controls the operation of the respective devices (units).

Each of the image forming units 1Y, 1M, 1C, and 1K of the image forming apparatus 100 is equipped with a photoreceptor 11 that retains a toner image on a surface and rotates in the arrow A direction.

On the periphery of the photoreceptor 11, a charger 12 that charges the photoreceptor 11 is installed as one example of the charging unit, and a laser exposure device 13 (in the drawing, the exposure beam is denoted by reference symbol Bm) that writes an electrostatic latent image on the photoreceptor 11 is installed as one example of the latent image forming unit.

Also on the periphery of the photoreceptor 11, a developing system 14 that contains a toner of a corresponding color component and visualizes the electrostatic latent image on the photoreceptor 11 by using the toner is installed as one example of the developing unit, and a first transfer roll 16 that transfers the toner images of the respective color components on the photoreceptors 11 onto the intermediate transfer belt 15 in the first transfer unit 10.

Also on the periphery of the photoreceptor 11, a photoreceptor cleaner 17 that removes the residual toner on the photoreceptor 11 is installed, and electrophotographic devices, namely, the charger 12, the laser exposure device 13, the developing system 14, the first transfer roll 16, and the photoreceptor cleaner 17, are sequentially installed along the rotation direction of the photoreceptor 11. The image forming units 1Y, 1M, 1C, and 1K are arranged in a substantially straight line in the order of yellow (Y), magenta (M), cyan (C), and black (K) from the upstream side of the intermediate transfer belt 15.

The intermediate transfer belt 15, which is one example of the intermediate transfer body, is formed to have a volume resistivity of, for example, 1×10⁶ Ωcm or more and 1×10¹⁴ Ωcm or less, and a thickness of about 0.1 mm.

The intermediate transfer belt 15 is driven by various types of rolls to circulate (rotated) at a velocity suitable for the purpose in the B direction illustrated in FIG. 1. The various type of rolls are a driving roll 31 that is driven by a motor (not illustrated) having excellent constant-velocity properties and thereby rotates the intermediate transfer belt 15; a supporting roll 32 that supports the intermediate transfer belt 15 extending along the direction in which the photoreceptors 11 are arranged; a tension applying roll 33 that applies a tension to the intermediate transfer belt 15 and functions as a correction roll that prevents meandering of the intermediate transfer belt 15; a rear roll 25 installed in the second transfer unit 20; and a cleaning rear roll 34 installed in a cleaning unit that scrapes off the residual toner on the intermediate transfer belt 15.

The first transfer unit 10 is formed of a first transfer roll 16 arranged to oppose the photoreceptor 11 with the intermediate transfer belt 15 therebetween. The first transfer roll 16 is arranged to be in pressure-contact with the photoreceptor 11 with the intermediate transfer belt 15 therebetween, and a voltage (first transfer bias) having an opposite polarity to the toner charging polarity (minus polarity, the same applies hereinafter) is applied to the first transfer roll 16. In this manner, the toner images on the photoreceptors 11 are sequentially electrostatically attracted to the intermediate transfer belt 15 so as to form a superimposed toner image on the intermediate transfer belt 15.

The second transfer unit 20 is formed of the rear roll 25 and a second transfer roll 22 arranged on the toner image-retaining surface side of the intermediate transfer belt 15.

The rear roll 25 is formed so that the surface resistivity is 1×10⁷ Ω/□ or more and 1×10¹⁰Ω/□ or less, and the hardness is set to, for example, 70° (Asker C, produced by Kobunshi Keiki Co., Ltd., the same applies hereinafter). This rear roll 25 is disposed on the rear surface side of the intermediate transfer belt 15 so as to function as a counter electrode for the second transfer roll 22, and a metal power feed roll 26 to which a second transfer bias is stably applied is arranged to be in contact with the rear roll 25.

Meanwhile, the second transfer roll 22 is a cylindrical roll having a volume resistivity of 10^{7.5} Ωcm or more and 10^{8.5} Ωcm or less. The second transfer roll 22 is arranged to be in pressure-contact with the rear roll 25 with the intermediate transfer belt 15 therebetween, and is earthed so that the second transfer bias is formed between the second transfer roll 22 and the rear roll 25. As a result, a toner image is transferred (second transfer) onto the sheet K transported to the second transfer unit 20.

An intermediate transfer belt cleaning member 35 that removes residual toner and paper dust on the intermediate transfer belt 15 after the second transfer and cleans the surface of the intermediate transfer belt 15 is disposed on the downstream of the second transfer unit 20 of the intermediate transfer belt 15. The intermediate transfer belt cleaning member 35 is detachable from and attachable to the intermediate transfer belt 15.

A second transfer roll cleaning member 22A that removes residual toner and paper dust on the second transfer roll 22 after the second transfer and cleans the surface of the intermediate transfer belt 15 is disposed on the downstream of the second transfer unit 20 of the second transfer roll 22. An example of the second transfer roll cleaning member 22A is a cleaning blade. Alternatively, a cleaning roll may be used.

The intermediate transfer belt 15, the first transfer roll 16, and the second transfer roll 22 correspond to one example of the transfer device.

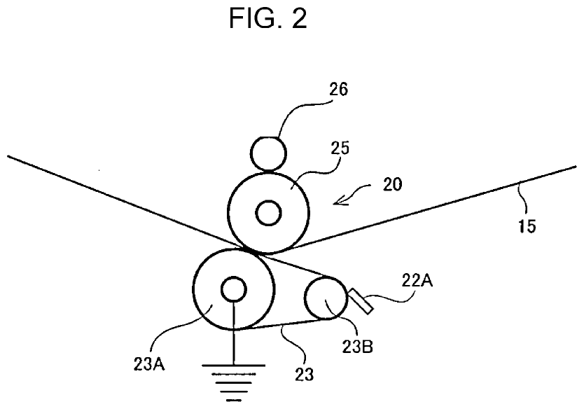

Here, the image forming apparatus 100 may have a structure in which a second transfer belt (one example of the second transfer member) substitutes the second transfer roll 22. Specifically, as illustrated in FIG. 2, the image forming apparatus 100 may be equipped with a second transfer device that includes a second transfer belt 23, a drive roll 23A arranged to face the rear roll 25 with the intermediate transfer belt 15 and the second transfer belt 23 therebetween, and an idler roll 23B that keeps the second transfer belt 23 taut in collaboration with the drive roll 23A.

Meanwhile, a reference sensor (home position sensor) 42 that generates a reference signal for controlling the image formation timing in the image forming units 1Y, 1M, 1C, and 1K is disposed upstream of the yellow image forming unit 1Y. An image density sensor 43 for adjusting the image quality is disposed downstream of the black image forming unit 1K. The reference sensor 42 generates a reference signal by recognizing a mark on the rear side of the intermediate transfer belt 15, and the image forming units 1Y, 1M, 1C, and 1K start image formation when the controller 40 sends commands on the basis of recognition of the reference signal.

Furthermore, in the image forming apparatus of this exemplary embodiment, the sheet feeder system for feeding the sheet K includes a sheet storing unit 50 that stores the sheets K, a sheet supply roll 51 that picks up the sheet K from a stack in the sheet storing unit 50 and feeds the sheet K at a predetermined timing, a feeder roll 52 that feeds the sheet K picked up by the sheet supply roll 51, a feeder guide 53 that sends the sheet K fed by the feeder roll 52 to the second transfer unit 20, a feeder belt 55 that feeds the sheet K to the fixing device 60 after the second transfer by the second transfer roll 22, and a fixing inlet guide 56 that guides the sheet K to the fixing device 60.

Next, a basic image forming process carried out in the image forming apparatus of this exemplary embodiment is described.

According to the image forming apparatus of this exemplary embodiment, image data output from an image reader or a personal computer (PC) (not illustrated) or the like is subjected to image processing by using an image processing device (not illustrated), and then image forming operation is executed in the image forming units 1Y, 1M, 1C, and 1K.

In the image processing device, the input reflectance data is subjected to image processing, such as various types of image editing including shading correction, misalignment correction, brightness/color space conversion, gamma correction, frame deletion, color editing, and moving. The image data subjected to image processing is converted into color material tone data of four colors, namely, Y, M, C, and K, and output to the laser exposure device 13.

In the laser exposure device 13, in response to the input color material tone data, exposure beams Bm emitted from, for example, semiconductor lasers respectively irradiate the photoreceptors 11 of the image forming units 1Y, 1M, 1C, and 1K. After the surfaces of the photoreceptors 11 in the image forming units 1Y, 1M, 1C, and 1K are charged by the chargers 12, the surfaces are scanned and exposed with the laser exposure devices 13 so as to form electrostatic latent images. The formed electrostatic latent images are developed into toner images of four colors, namely, Y, M, C, and K, in the image forming units 1Y, 1M, 1C, and 1K.

The toner images formed on the photoreceptors 11 in the image forming units 1Y, 1M, 1C, and 1K are transferred onto the intermediate transfer belt 15. This transfer occurs at the first transfer unit 10 where the photoreceptors 11 contact the intermediate transfer belt 15. More specifically, at the first transfer unit 10, the first transfer roll 16 applies, to the substrate of the intermediate transfer belt 15, a voltage (first transfer bias) having a polarity opposite to the toner charging polarity (minus polarity), and the toner images are sequentially superimposed on the surface of the intermediate transfer belt 15 so as to carry out the first transfer.

After the toner images are sequentially transferred (first transfer) onto the surface of the intermediate transfer belt 15, the intermediate transfer belt 15 moves so as to transport the toner images to the second transfer unit 20. In the feeder unit, when the toner images are transported to the second transfer unit 20, the sheet supply roll 51 rotates in synchronization with the timing of transporting the toner images to the second transfer unit 20 so as to feed the sheet K of a desired size from the sheet storing unit 50. The sheet K supplied by the sheet supply roll 51 is transported by the feeder roll 52, passes through the feeder guide 53, and reaches the second transfer unit 20. Before reaching the second transfer unit 20, the sheet K makes a temporary stop. An alignment roll (not illustrated) rotates in synchronization with the timing of the movement of the intermediate transfer belt 15 retaining the toner images so that the position of the sheet K and the positions of the toner images are aligned.

In the second transfer unit 20, the second transfer roll 22 is pressed against the rear roll 25 with the intermediate transfer belt 15 therebetween. At this stage, the sheet K fed at the synchronized timing is tucked between the intermediate transfer belt 15 and the second transfer roll 22. Here, when a voltage (second transfer bias) having the same polarity as the toner charging polarity (minus polarity) is applied from the power feed roll 26, a transfer electric field is formed between the second transfer roll 22 and the rear roll 25. The unfixed toner images retained on the intermediate transfer belt 15 are electrostatically simultaneously transferred onto the sheet K at the second transfer unit 20 where the images are pressed by the second transfer roll 22 and the rear roll 25.

Subsequently, the sheet K having the electrostatically transferred toner images thereon is transported as is while being detached from the intermediate transfer belt 15 by the second transfer roll 22, and is then transported to the feeder belt 55 downstream of the second transfer roll 22 in the sheet feeding direction. The feeder belt 55 transports the sheet K to the fixing device 60 at a feeding velocity optimum for the fixing device 60. The unfixed toner images on the sheet K fed to the fixing device 60 are fixed to the sheet K by being subjected to a fixing process involving heat and pressure in the fixing device 60. The sheet K having the fixed image thereon is fed to a discharged sheet storing unit (not illustrated) in a discharge unit of the image forming apparatus.

Meanwhile, after the transfer to the sheet K is completed, the residual toner remaining on the intermediate transfer belt 15 is transported to the cleaning unit as the intermediate transfer belt 15 rotates, and is removed from the intermediate transfer belt 15 by the cleaning rear roll 34 and the intermediate transfer belt cleaner 35.

### Photoreceptor

One example of the photoreceptor 11 (hereinafter may be referred as the “photoreceptor of the exemplary embodiment”) will now be described with reference to the drawings.

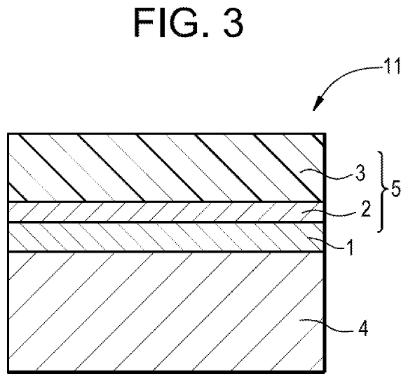

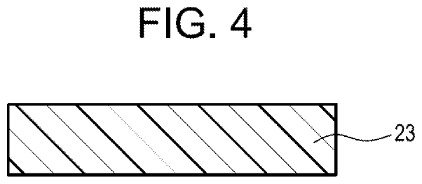

The photoreceptor 11 illustrated in FIG. 3 includes, for example, a conductive support 4, and an undercoat layer 1, a charge generating layer 2, and a charge transporting layer 3 that are stacked in this order on the conductive support 4. The charge generating layer 2 and the charge transporting layer 3 constitute a photosensitive layer 5.

The photoreceptor 11 may have a layer structure that does not include the undercoat layer 1.

The photoreceptor 11 may include a single-layer-type photosensitive layer in which the functions of the charge generating layer 2 and the charge transporting layer 3 are integrated. In the case of a photosensitive layer having a single-layer-type photosensitive layer, the single-layer-type photosensitive layer constitutes the outermost surface layer.

Alternatively, the photoreceptor 11 may include a surface protection layer on the charge transporting layer 3 or the single-layer-type photosensitive layer. In the case of a photoreceptor having a surface protection layer, the surface protection layer constitutes the outermost surface layer.

In the description below, the respective layers of the photoreceptor 11 of this exemplary embodiment are described in detail. In the description below, the reference signs are omitted.

### Outermost Surface Layer

First, the outermost surface layer that contains PTFE particles and a fluorine-containing dispersant and that has a PFOA content of 25 ppb or less relative to the PTFE particles is described. The structure of this outermost surface layer is applied to a layer (charge transporting layer, single-layer-type photosensitive layer, or surface protection layer) that forms the outermost surface layer described below.

The dispersant-attached PTFE particles of this exemplary embodiment has a perfluorooctanoic acid (PFOA) content of 25 ppb or less relative to the polytetrafluoroethylene particles (PTFE particles).

### PFOA Content

In the outermost surface layer, the PFOA content is 25 ppb or less relative to the PTFE particles. From the viewpoint of improving the dispersed state maintaining property, the PFOA content is preferably 0 ppb or more and 20 ppb or less and is more preferably 0 ppb or more and 15 ppb or less. Here, the “ppb” is on a mass basis.

An example of the method for reducing the PFOA content is a method that involves thoroughly washing the PTFE particles with pure water, alkaline water, an alcohol (methanol, ethanol, isopropanol, or the like), a ketone (acetone, methyl ethyl ketone, methyl isobutyl ketone, or the like), an ester (ethyl acetate or the like), or any other common organic solvent (toluene, tetrahydrofuran, or the like). Washing may be performed at room temperature, but washing under heating improves efficiency.

The PFOA content is a value measured by the following method.

### Pretreatment of Sample

The outermost surface layer is immersed in a solvent (for example, tetrahydrofuran) to dissolve substances other than the PTFE particles and the substances insoluble in the solvent, the resulting solution is added to pure water dropwise, and precipitates are separated by filtration. A solution containing perfluorooctanoic acid (PFOA) obtained during this process is collected. The insoluble matter obtained by filtration is further dissolved in a solvent, the resulting solution is added to pure water dropwise, and precipitates are separated by filtration. Collection of the solution containing PFOA obtained as a result is performed five times, and the aqueous solution collected in all collection operations is used as a pretreated aqueous solution.

### Measurement

A sample solution is prepared from the pretreated aqueous solution obtained as described above and is adjusted and measured in accordance with the method indicated in “Analysis of Perfluorooctanesulfonic Acid (PFOS) and Perfluorooctanoic Acid (PFOA) in Environmental Water, Sediment, and Living Organisms” by Environment and Health Laboratory of Iwate Prefecture.

### PTFE Particles

The average particle diameter of the PTFE particles (average particle diameter of the dispersant-attached PTFE particles) is not particularly limited, but may be 0.2 μm or more and 4.5 μm or less or more preferably 0.2 μm or more and 4 μm or less. The PTFE particles having an average particle diameter of 0.2 μm or more and 4.5 μm or less have a tendency to contain a large amount of PFOA. Thus, the PTFE particles having an average particle diameter of 0.2 μm or more and 4.5 μm or less tends to be in a degraded dispersed state particularly when the state of the components mixed together changes. However, when the PFOA content is suppressed to be in the aforementioned range, the dispersed state maintaining property of the PTFE particles having an average particle diameter of 0.2 μm or more and 4.5 μm or less is improved despite the change in the state of the components mixed together.

The average particle diameter of the PTFE particles is the value measured by the following method.

Using a scanning electron microscope (SEM), particles are observed at a magnification of, for example, 5000× or more, the maximum diameters of the fluororesin particles (secondary particles formed by agglomeration of primary particles) are measured, and the average of fifty particles is used as the average particle diameter of the PTFE particles. The SEM used is JSM-6700F produced by JEOL Ltd., and a secondary electron image at an accelerating voltage of 5 kV is observed.

The PTFE particle content relative to the total solid content in the outermost surface layer is preferably 1 mass % or more and 30 mass % or less, is more preferably 3 mass % or more and 20 mass % or less, and is yet more preferably 5 mass % or more and 15 mass % or less.

### Fluorine-Containing Dispersant

The fluorine-containing dispersant is at least partly attached to the surfaces of the PTFE particles and contained in the outermost surface layer.

Examples of the fluorine-containing dispersant include polymers obtained by homopolymerization or copolymerization of polymerizable compounds having fluorinated alkyl groups (hereinafter these polymers may be referred to as “fluorinated alkyl group-containing polymers”).

Specific examples of the fluorine-containing dispersant include homopolymers of (meth)acrylates having fluorinated alkyl groups, and random or block copolymers obtained from (meth)acrylates having fluorinated alkyl groups and fluorine atom-free monomers. Note that (meth)acrylates refer to both acrylates and methacrylates.

Examples of the (meth)acrylates having fluorinated alkyl groups include 2,2,2-trifluoroethyl (meth)acrylate and 2,2,3,3,3-pentafluoropropyl (meth)acrylate.

Examples of the fluorine atom-free monomers include (meth)acrylate, isobutyl (meth)acrylate, t-butyl (meth)acrylate, isooctyl (meth)acrylate, lauryl (meth)acrylate, stearyl (meth)acrylate, isobornyl (meth)acrylate, cyclohexyl (meth)acrylate, 2-methoxyethyl (meth)acrylate, methoxytriethylene glycol (meth)acrylate, 2-ethoxyethyl (meth)acrylate, tetrahydrofurfuryl (meth)acrylate, benzyl (meth)acrylate, ethylcarbitol (meth)acrylate, phenoxyethyl (meth)acrylate, 2-hydroxy (meth)acrylate, 2-hydroxypropyl (meth)acrylate, 4-hydroxybutyl (meth)acrylate, methoxypolyethylene glycol (meth)acrylate, phenoxypolyethylene glycol (meth)acrylate, hydroxyethyl-o-phenylphenol (meth)acrylate, and o-phenylphenol glycidyl ether (meth)acrylate.

Other specific examples of the fluorine-containing dispersant include block or branched polymers disclosed in the U.S. Pat. No. 5,637,142 and Japanese Patent No. 4251662. Other specific examples of the fluorine-containing dispersant include fluorine-based surfactants.

Among these, the fluorine-containing dispersant is preferably a fluorinated alkyl group-containing polymer having a structural unit represented by general formula (FA) below and is more preferably a fluorinated alkyl group-containing polymer having a structural unit represented by general formula (FA) below and a structural unit represented by general formula (FB) below.

In the description below, the fluorinated alkyl group-containing polymer having a structural unit represented by general formula (FA) below and a structural unit represented by general formula (FB) below is described.

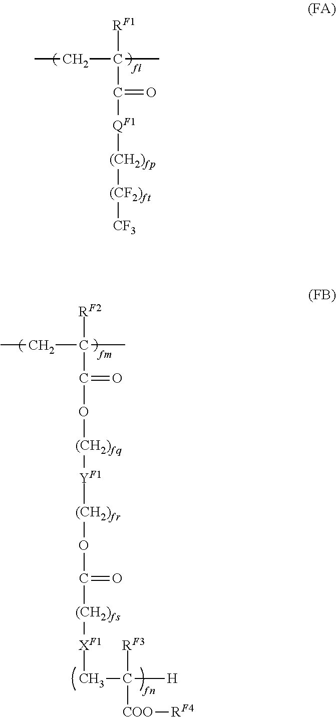

In general formulae (FA) and (FB), R^{F1}, R^{F2}, R^{F3}, and R^{F4} each independently represent a hydrogen atom or an alkyl group,

X^{F1} represents an alkylene chain, a halogen-substituted alkylene chain, —S—, —O—, —NH—, or a single bond,

Y^{F1} represents an alkylene chain, a halogen-substituted alkylene chain, —(C_{f}—H_{2fx-1}(OH))—, or a single bond,

Q^{F1} represents —O— or —NH—,

fl, fm, and fn each independently represent an integer of 1 or more,

fp, fq, fr, and fs each independently represent 0 or an integer of 1 or more,

ft represents an integer of 1 or more and 7 or less, and

fx represents an integer of 1 or more.

In general formulae (FA) and (FB), a hydrogen atom, a methyl group, an ethyl group, a propyl group, etc., are preferable as the groups represented by R^{F1}, R^{F2}, R^{F3}, and R^{F4}. A hydrogen atom and a methyl group are more preferable, and a methyl group is yet more preferable.

In general formulae (FA) and (FB), linear or branched alkylene groups having 1 to 10 carbon atoms may be used as the alkylene chains (unsubstituted alkylene chains and halogen-substituted alkylene chains) represented by X^{F1} and Y^{F1}.

In —(C_{fx}H_{2fx-1}(OH))— represented by Y^{F1}, fx may represent an integer of 1 or more and 10 or less.

Furthermore, fp, fq, fr, and fs may each independently represent 0 or an integer of 1 or more and 10 or less.

For example, fn may be 1 or more and 60 or less.

In the fluorine-containing dispersant, the ratio of the structural unit represented by general formula (FA) to the structural unit represented by structural unit (FB), in other words, fl:fm, may be in the range of 1:9 to 9:1 or may be in the range of 3:7 to 7:3.

Furthermore, the fluorine-containing dispersant may further contain a structural unit represented by general formula (FC) in addition to the structural unit represented by general formula (FA) and the structural unit represented by general formula (FB). The content ratio (fl+fm:fz) of the total (fl+fm) of the structural units represented by general formulae (FA) and (FB) to the structural unit represented by general formula (FC) is preferably in the range of 10:0 to 7:3 and is more preferably in the range of 9:1 to 7:3.

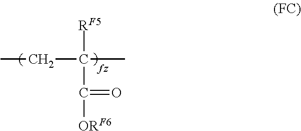

In general formula (FC), R^{F5} and R^{F6} each independently represent a hydrogen atom, an alkyl group, or -AO-R^{F7} (where AO represents an alkylene oxide group and R^{F7} represents a hydrogen atom or an alkyl group). Furthermore, fz represents an integer of 1 or more.

In general formula (FC), a hydrogen atom, a methyl group, an ethyl group, a propyl group, etc., may be used as the groups represented by R^{F5} and R^{F6}. A hydrogen atom and a methyl group are more preferable, and a methyl group is yet more preferable.

Examples of the commercially available products of the fluorine-containing dispersant include GF300 and GF400 (produced by Toagosei Co, Ltd.), Surflon series (produced by AGC SEIMI CHEMICAL CO., LTD.), Ftergent series (produced by NEOS Company Limited), PF series (produced by Kitamura Chemicals Co., Ltd.), Megaface series (produced by DIC Corporation), and FC series (produced by 3M).

The weight-average molecular weight of the fluorine-containing dispersant may be, for example, 2000 or more and 250000 or less, may be 3000 or more and 150000 or less, or may be 50000 or more and 100000 or less.

The weight-average molecular weight of the fluorine-containing dispersant is a value measured by gel permeation chromatography (GPC). The molecular weight measurement by GPC is conducted by, for example, using GPC·HLC-8120 produced by TOSOH CORPORATION as a measurement instrument with TSKgel GMHHR-M+TSKgel GMHHR-M columns (7.8 mm I.D., 30 cm) produced by TOSOH CORPORATION and a chloroform solvent, and calculating the molecular weight from the measurement results by using a molecular weight calibration curve prepared from a monodisperse polystyrene standard sample.

The amount of the fluorine-containing dispersant contained relative to, for example, the PTFE particle is preferably 0.5 mass % or more and 10 mass % or less and more preferably 1 mass % or more and 7 mass % or less.

The fluorine-containing dispersants may be used alone or in combination.

### Conductive Substrate

Examples of the conductive substrate include metal plates, metal drums, and metal belts that contain metals (aluminum, copper, zinc, chromium, nickel, molybdenum, vanadium, indium, gold, platinum, etc.) or alloys (stainless steel etc.). Other examples of the conductive substrate include paper sheets, resin films, and belts coated, vapor-deposited, or laminated with conductive compounds (for example, conductive polymers and indium oxide), metals (for example, aluminum, palladium, and gold), or alloys. Here, “conductive” means having a volume resistivity of less than 10¹³ Ωcm.

The surface of the conductive substrate may be roughened to a center-line average roughness Ra of 0.04 μm or more and 0.5 μm or less in order to suppress interference fringes that occur when the electrophotographic photoreceptor used in a laser printer is irradiated with a laser beam. When incoherent light is used as a light source, there is no need to roughen the surface to prevent interference fringes, but roughening the surface suppresses generation of defects due to irregularities on the surface of the conductive substrate and thus is desirable for extending the lifetime.

Examples of the surface roughening method include a wet honing method with which an abrasive suspended in water is sprayed onto a conductive support, a centerless grinding with which a conductive substrate is pressed against a rotating grinding stone to perform continuous grinding, and an anodization treatment.

Another example of the surface roughening method does not involve roughening the surface of a conductive substrate but involves dispersing a conductive or semi-conductive powder in a resin and forming a layer of the resin on a surface of a conductive substrate so as to create a rough surface by the particles dispersed in the layer.

The surface roughening treatment by anodization involves forming an oxide film on the surface of a conductive substrate by anodization by using a metal (for example, aluminum) conductive substrate as the anode in an electrolyte solution. Examples of the electrolyte solution include a sulfuric acid solution and an oxalic acid solution. However, a porous anodization film formed by anodization is chemically active as is, is prone to contamination, and has resistivity that significantly varies depending on the environment. Thus, a pore-sealing treatment may be performed on the porous anodization film so as to seal fine pores in the oxide film by volume expansion caused by hydrating reaction in pressurized steam or boiling water (a metal salt such as a nickel salt may be added) so that the oxide is converted into a more stable hydrous oxide.

The thickness of the anodization film may be, for example, 0.3 μm or more and 15 μm or less. When the thickness is within this range, a barrier property against injection tends to be exhibited, and the increase in residual potential caused by repeated use tends to be suppressed.

The conductive substrate may be subjected to a treatment with an acidic treatment solution or a Boehmite treatment.

The treatment with an acidic treatment solution is, for example, conducted as follows. First, an acidic treatment solution containing phosphoric acid, chromic acid, and hydrofluoric acid is prepared. The blend ratios of phosphoric acid, chromic acid, and hydrofluoric acid in the acidic treatment solution may be, for example, in the range of 10 mass % or more and 11 mass % or less for phosphoric acid, in the range of 3 mass % or more and 5 mass % or less for chromic acid, and in the range of 0.5 mass % or more and 2 mass % or less for hydrofluoric acid; and the total concentration of these acids may be in the range of 13.5 mass % or more and 18 mass % or less. The treatment temperature may be, for example, 42° C. or more and 48° C. or less. The thickness of the film may be 0.3 μm or more and 15 μm or less.

The Boehmite treatment is conducted by immersing a conductive substrate in pure water at 90° C. or higher and 100° C. or lower for 5 to 60 minutes or by bringing a conductive substrate into contact with pressurized steam at 90° C. or higher and 120° C. or lower for 5 to 60 minutes. The thickness of the film may be 0.1 μm or more and 5 μm or less. The Boehmite-treated body may be further anodized by using an electrolyte solution, such as adipic acid, boric acid, a borate salt, a phosphate salt, a phthalate salt, a maleate salt, a benzoate salt, a tartrate salt, or a citrate salt, that has low film-dissolving power.

### Undercoat Layer

The undercoat layer is, for example, a layer that contains inorganic particles and a binder resin.

Examples of the inorganic particles include inorganic particles having a powder resistivity (volume resistivity) of 10² Ωcm or more and 10¹¹ Ωcm or less.

As the inorganic particles having this resistance value, for example, metal oxide particles such as tin oxide particles, titanium oxide particles, zinc oxide particles, or zirconium oxide particles are preferable, and, in particular, zinc oxide particles are preferable.

The specific surface area of the inorganic particles measured by the BET method may be, for example, 10 m²/g or more.

The volume-average particle diameter of the inorganic particles may be, for example, 50 nm or more and 2000 nm or less (or may be 60 nm or more and 1000 nm or less).

The amount of the inorganic particles contained relative to the binder resin is, for example, preferably 10 mass % or more and 80 mass % or less, and is more preferably 40 mass % or more and 80 mass % or less.

The inorganic particles may be surface-treated. A mixture of two or more inorganic particles subjected to different surface treatments or having different particle diameters may be used.

Examples of the surface treatment agent include a silane coupling agent, a titanate-based coupling agent, an aluminum-based coupling agent, and a surfactant. In particular, a silane coupling agent is preferable, and an amino-group-containing silane coupling agent is more preferable.

Examples of the amino-group-containing silane coupling agent include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

Two or more silane coupling agents may be mixed and used. For example, an amino-group-containing silane coupling agent may be used in combination with an additional silane coupling agent. Examples of this additional silane coupling agent include, but are not limited to, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment method that uses a surface treatment agent may be any known method, for example, may be a dry method or a wet method.

The treatment amount of the surface treatment agent may be, for example, 0.5 mass % or more and 10 mass % or less relative to the inorganic particles.

Here, the undercoat layer may contain inorganic particles and an electron-accepting compound (acceptor compound) from the viewpoints of long-term stability of electrical properties and carrier blocking properties.

Examples of the electron-accepting compound include electron transporting substances, such as quinone compounds such as chloranil and bromanil; tetracyanoquinodimethane compounds; fluorenone compounds such as 2,4,7-trinitrofluorenone and 2,4,5,7-tetranitro-9-fluorenone; oxadiazole compounds such as 2-(4-biphenyl)-5-(4-t-butylphenyl)-1,3,4-oxadiazole, 2,5-bis (4-naphthyl)-1,3,4-oxadiazole, and 2,5-bis(4-diethylaminophenyl)-1,3,4-oxadiazole; xanthone compounds; thiophene compounds; and diphenoquinone compounds such as 3,3′,5,5′-tetra-t-butyldiphenoquinone.

In particular, a compound having an anthraquinone structure may be used as the electron-accepting compound. Examples of the compound having an anthraquinone structure include hydroxyanthraquinone compounds, aminoanthraquinone compounds, and aminohydroxyanthraquinone compounds, and more specific examples thereof include anthraquinone, alizarin, quinizarin, anthrarufin, and purpurin.

The electron-accepting compound may be dispersed in the undercoat layer along with the inorganic particles, or may be attached to the surfaces of the inorganic particles.

Examples of the method for attaching the electron-accepting compound onto the surfaces of the inorganic particles include a dry method and a wet method.

The dry method is, for example, a method with which, while inorganic particles are stirred with a mixer or the like having a large shear force, an electron-accepting compound as is or dissolved in an organic solvent is added dropwise or sprayed along with dry air or nitrogen gas so as to cause the electron-accepting compound to attach to the surfaces of the inorganic particles. When the electron-accepting compound is added dropwise or sprayed, the temperature may be equal to or lower than the boiling point of the solvent. After the electron-accepting compound is added dropwise or sprayed, baking may be further conducted at 100° C. or higher. The temperature and time for baking are not particularly limited as long as the electrophotographic properties are obtained.

The wet method is, for example, a method with which, while inorganic particles are dispersed in a solvent by stirring, ultrasonically, or by using a sand mill, an attritor, or a ball mill, the electron-accepting compound is added, followed by stirring or dispersing, and then the solvent is removed to cause the electron-accepting compound to attach to the surfaces of the inorganic particles. The solvent is removed by, for example, filtration or distillation. After removing the solvent, baking may be further conducted at 100° C. or higher. The temperature and time for baking are not particularly limited as long as the electrophotographic properties are obtained. In the wet method, the moisture contained in the inorganic particles may be removed before adding the electron-accepting compound. For example, the moisture may be removed by stirring and heating the inorganic particles in a solvent or by boiling together with the solvent.

Attaching the electron-accepting compound may be conducted before, after, or simultaneously with the surface treatment of the inorganic particles by a surface treatment agent.

The amount of the electron-accepting compound contained relative to the inorganic particles may be, for example, 0.01 mass % or more and 20 mass % or less, and is preferably 0.01 mass % or more and 10 mass % or less.

Examples of the binder resin used in the undercoat layer include known materials such as known polymer compounds such as acetal resins (for example, polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenolic resins, phenol-formaldehyde resins, melamine resins, urethane resins, alkyd resins, and epoxy resins; zirconium chelate compounds; titanium chelate compounds; aluminum chelate compounds; titanium alkoxide compounds; organic titanium compounds; and silane coupling agents.

Other examples of the binder resin used in the undercoat layer include charge transporting resins that have charge transporting groups, and conductive resins (for example, polyaniline).

Among these, a resin that is insoluble in the coating solvent in the overlying layer is suitable as the binder resin used in the undercoat layer. Examples of the particularly suitable resin include thermosetting resins such as a urea resin, a phenolic resin, a phenol-formaldehyde resin, a melamine resin, a urethane resin, an unsaturated polyester resin, an alkyd resin, and an epoxy resin; and a resin obtained by a reaction between a curing agent and at least one resin selected from the group consisting of a polyamide resin, a polyester resin, a polyether resin, a methacrylic resin, an acrylic resin, a polyvinyl alcohol resin, and a polyvinyl acetal resin.

When two or more of these binder resins are used in combination, the mixing ratios are set as necessary.

The undercoat layer may contain various additives to improve electrical properties, environmental stability, and image quality.

Examples of the additives include known materials such as electron transporting pigments based on polycyclic condensed materials and azo materials, zirconium chelate compounds, titanium chelate compounds, aluminum chelate compounds, titanium alkoxide compounds, organic titanium compounds, and silane coupling agents. The silane coupling agent is used to surface-treat the inorganic particles as mentioned above, but may be further added as an additive to the undercoat layer.

Examples of the silane coupling agent used as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compounds include zirconium butoxide, zirconium ethyl acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compounds include tetraisopropyl titanate, tetra-n-butyl titanate, butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compounds include aluminum isopropylate, monobutoxyaluminum diisopropylate, aluminum butylate, diethylacetoacetate aluminum diisopropylate, and aluminum tris(ethylacetoacetate).

These additives may be used alone, or two or more compounds may be used as a mixture or a polycondensation product.

The undercoat layer may have a Vickers hardness of 35 or more.

In order to suppress moire images, the surface roughness (ten-point average roughness) of the undercoat layer may be adjusted to be in the range of 1/(4n) (n represents the refractive index of the overlying layer) to ½ of λ representing the laser wavelength used for exposure.

In order to adjust the surface roughness, resin particles and the like may be added to the undercoat layer. Examples of the resin particles include silicone resin particles and crosslinking polymethyl methacrylate resin particles. The surface of the undercoat layer may be polished to adjust the surface roughness. Examples of the polishing method included buff polishing, sand blasting, wet honing, and grinding.

The undercoat layer may be formed by any known method. For example, a coating film is formed by using an undercoat layer-forming solution prepared by adding the above-mentioned components to a solvent, dried, and, if needed, heated.

Examples of the solvent used for preparing the undercoat layer-forming solution include known organic solvents, such as alcohol solvents, aromatic hydrocarbon solvents, halogenated hydrocarbon solvents, ketone solvents, ketone alcohol solvents, ether solvents, and ester solvents.

Specific examples of the solvent include common organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method for dispersing inorganic particles in preparing the undercoat layer-forming solution include known methods that use a roll mill, a ball mill, a vibrating ball mill, an attritor, a sand mill, a colloid mill, and a paint shaker.

Examples of the method for applying the undercoat layer-forming solution to the conductive substrate include common methods such as a blade coating method, a wire bar coating method, a spray coating method, a dip coating method, a bead coating method, an air knife coating method, and a curtain coating method.

The thickness of the undercoat layer is preferably set within the range of 15 μm or more, and more preferably within the range of 20 μm or more and 50 μm or less.

### Intermediate Layer

Although not illustrated in the drawings, an intermediate layer may be further provided between the undercoat layer and the photosensitive layer.

The intermediate layer is, for example, a layer that contains a resin. Examples of the resin used in the intermediate layer include polymer compounds such as acetal resins (for example, polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may contain an organic metal compound. Examples of the organic metal compound used in the intermediate layer include organic metal compounds containing metal atoms such as zirconium, titanium, aluminum, manganese, and silicon.

These compounds used in the intermediate layer may be used alone, or two or more compounds may be used as a mixture or a polycondensation product.

In particular, the intermediate layer may be a layer that contains an organic metal compound that contains zirconium atoms or silicon atoms.

The intermediate layer may be formed by any known method. For example, a coating film is formed by using an intermediate layer-forming solution prepared by adding the above-mentioned components to a solvent, dried, and, if needed, heated.

Examples of the application method for forming the intermediate layer include common methods such as a dip coating method, a lift coating method, a wire bar coating method, a spray coating method, a blade coating method, a knife coating method, and a curtain coating method.

The thickness of the intermediate layer may be set within the range of, for example, 0.1 μm or more and 3 μm or less. The intermediate layer may be used as the undercoat layer.

### Charge Generating Layer

The charge generating layer is, for example, a layer that contains a charge generating material and a binder resin. The charge generating layer may be a vapor deposited layer of a charge generating material. The vapor deposited layer of the charge generating material may be used when an incoherent light such as a light emitting diode (LED) or an organic electro-luminescence (EL) image array is used.

Examples of the charge generating material include azo pigments such as bisazo and trisazo pigments; fused-ring aromatic pigments such as dibromoanthanthrone; perylene pigments; pyrrolopyrrole pigments; phthalocyanine pigments; zinc oxide; and trigonal selenium.

Among these, in order to be compatible to the near-infrared laser exposure, a metal phthalocyanine pigment or a metal-free phthalocyanine pigment may be used as the charge generating material. Specific examples thereof include hydroxygallium phthalocyanine disclosed in Japanese Unexamined Patent Application Publication Nos. 5-263007 and 5-279591; chlorogallium phthalocyanine disclosed in Japanese Unexamined Patent Application Publication No. 5-98181; dichlorotin phthalocyanine disclosed in Japanese Unexamined Patent Application Publication Nos. 5-140472 and 5-140473; and titanyl phthalocyanine disclosed in Japanese Unexamined Patent Application Publication No. 4-189873.

In order to be compatible to the near ultraviolet laser exposure, the charge generating material may be a fused-ring aromatic pigment such as dibromoanthanthrone, a thioindigo pigment, a porphyrazine compound, zinc oxide, trigonal selenium, a bisazo pigment disclosed in Japanese Unexamined Patent Application Publication Nos. 2004-78147 and 2005-181992, or the like.

When an incoherent light source, such as an LED or an organic EL image array having an emission center wavelength in the range of 450 nm or more and 780 nm or less, is used, the charge generating material described above may be used; however, from the viewpoint of the resolution, when the photosensitive layer is as thin as 20 μm or less, the electric field intensity in the photosensitive layer is increased, charges injected from the substrate are decreased, and image defects known as black spots tend to occur. This is particularly noticeable when a charge generating material, such as trigonal selenium or a phthalocyanine pigment, that is of a p-conductivity type and easily generates dark current is used.

In contrast, when an n-type semiconductor, such as a fused-ring aromatic pigment, a perylene pigment, or an azo pigment, is used as the charge generating material, dark current rarely occurs and, even when the thickness is small, image defects known as black spots can be suppressed.

Examples of the n-type charge generating material include, but are not limited to, compounds (CG-1) to (CG-27) described in Japanese Unexamined Patent Application Publication No. 2012-155282, paragraphs [0288] to [0291].

Whether n-type or not is determined by a time-of-flight method commonly employed, on the basis of the polarity of the photocurrent flowing therein. A material in which electrons flow more smoothly as carriers than holes is determined to be of an n-type.

The binder resin used in the charge generating layer is selected from a wide range of insulating resins. Alternatively, the binder resin may be selected from organic photoconductive polymers, such as poly-N-vinylcarbazole, polyvinyl anthracene, polyvinyl pyrene, and polysilane.

Examples of the binder resin include, polyvinyl butyral resins, polyarylate resins (polycondensates of bisphenols and aromatic dicarboxylic acids etc.), polycarbonate resins, polyester resins, phenoxy resins, vinyl chloride-vinyl acetate copolymers, polyamide resins, acrylic resins, polyacrylamide resins, polyvinyl pyridine resins, cellulose resins, urethane resins, epoxy resins, casein, polyvinyl alcohol resins, and polyvinyl pyrrolidone resins. Here, “insulating” means having a volume resistivity of 10¹³ Ωcm or more.

These binder resins are used alone or in combination as a mixture.

The blend ratio of the charge generating material to the binder resin may be in the range of 10:1 to 1:10 on a mass ratio basis.

The charge generating layer may contain other known additives.

The charge generating layer may be formed by any known method. For example, a coating film is formed by using an charge generating layer-forming solution prepared by adding the above-mentioned components to a solvent, dried, and, if needed, heated. The charge generating layer may be formed by vapor-depositing a charge generating material. The charge generating layer may be formed by vapor deposition particularly when a fused-ring aromatic pigment or a perylene pigment is used as the charge generating material.

Specific examples of the solvent for preparing the charge generating layer-forming solution include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in combination as a mixture.

In order to disperse particles (for example, the charge generating material) in the charge generating layer-forming solution, a media disperser such as a ball mill, a vibrating ball mill, an attritor, a sand mill, or a horizontal sand mill, or a media-less disperser such as stirrer, an ultrasonic disperser, a roll mill, or a high-pressure homogenizer can be used. Examples of the high-pressure homogenizer include a collision-type homogenizer in which the dispersion in a high-pressure state is dispersed through liquid-liquid collision or liquid-wall collision, and a penetration-type homogenizer in which the fluid in a high-pressure state is caused to penetrate through fine channels.

In dispersing, it is effective to set the average particle diameter of the charge generating material in the charge generating layer-forming solution to 0.5 μm or less, preferably 0.3 μm or less, and more preferably 0.15 μm or less.

Examples of the method for applying the charge generating layer-forming solution to the undercoat layer (or the intermediate layer) include common methods such as a blade coating method, a wire bar coating method, a spray coating method, a dip coating method, a bead coating method, an air knife coating method, and a curtain coating method.

The thickness of the charge generating layer is preferably set within the range of, for example, 0.1 μm or more and 5.0 μm or less, and more preferably within the range of 0.2 μm or more and 2.0 μm or less.

### Charge Transporting Layer

The charge transporting layer is, for example, a layer that contains a charge transporting material and a binder resin. The charge transporting layer may be a layer that contains a polymer charge transporting material.

Examples of the charge transporting material include electron transporting compounds such as quinone compounds such as p-benzoquinone, chloranil, bromanil, and anthraquinone; tetracyanoquinodimethane compounds; fluorenone compounds such as 2,4,7-trinitrofluorenone; xanthone compounds; benzophenone compounds; cyanovinyl compounds; and ethylene compounds. Other examples of the charge transporting material include hole transporting compounds such as triarylamine compounds, benzidine compounds, aryl alkane compounds, aryl-substituted ethylene compounds, stilbene compounds, anthracene compounds, and hydrazone compounds. These charge transporting materials may be used alone or in combination, but are not limiting.

From the viewpoint of charge mobility, the charge transporting material may be a triaryl amine derivative represented by structural formula (a-1) below or a benzidine derivative represented by structural formula (a-2) below.

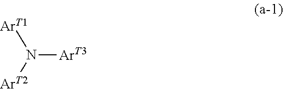

In structural formula (a-1), Ar^{T1}, Ar^{T2}, and Ar^{T3} each independently represent a substituted or unsubstituted aryl group, —C₆H₄—C(R^{T4})═C(R^{T5})═(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent for each of the groups described above include a halogen atom, an alkyl group having 1 to 5 carbon atoms, and an alkoxy group having 1 to 5 carbon atoms. Examples of the substituent for each of the groups described above include a substituted amino group substituted with an alkyl group having 1 to 3 carbon atoms.

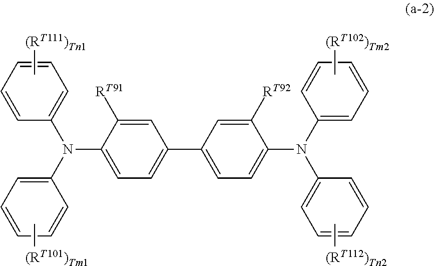

In structural formula (a-2), R^{T91} and R^{T92} each independently represent a hydrogen atom, a halogen atom, an alkyl group having 1 to 5 carbon atoms, or an alkoxy group having 1 to 5 carbon atoms. R^{T101}, R^{T102}, R^{T111}, and R^{T112} each independently represent a halogen atom, an alkyl group having 1 to 5 carbon atoms, an alkoxy group having 1 to 5 carbon atoms, an amino group substituted with an alkyl group having 1 or 2 carbon atoms, a substituted or unsubstituted aryl group, —C(R^{T12})═C(R^{T13})(R^{T14}), or —CH═CH—CH═C(R^{T15})(R^{T16}); and R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or more and 2 or less.

Examples of the substituent for each of the groups described above include a halogen atom, an alkyl group having 1 to 5 carbon atoms, and an alkoxy group having 1 to 5 carbon atoms. Examples of the substituent for each of the groups described above include a substituted amino group substituted with an alkyl group having 1 to 3 carbon atoms.

Here, among the triarylamine derivatives represented by structural formula (a-1) and the benzidine derivatives represented by structural formula (a-2) above, a triarylamine derivative having —C₆H₄—CH═CH—CH═C(R^{T7})(R^{T8}) or a benzidine derivative having —CH═CH—CH═C(R^{T15})(R^{T16}) may be used from the viewpoint of the charge mobility.

Examples of the polymer charge transporting material that can be used include known charge transporting materials such as poly-N-vinylcarbazole and polysilane. In particular, polyester polymer charge transporting materials disclosed in Japanese Unexamined Patent Application Publication Nos. 8-176293 and 8-208820 are particularly preferable. The polymer charge transporting material may be used alone or in combination with a binder resin.

Examples of the binder resin used in the charge transporting layer include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly-N-vinylcarbazole, and polysilane. Among these, a polycarbonate resin or a polyarylate resin may be used as the binder resin. These binder resins are used alone or in combination.

The blend ratio of the charge transporting material to the binder resin may be in the range of 10:1 to 1:5 on a mass ratio basis.

The charge transporting layer may contain other known additives.

The charge transporting layer may be formed by any known method. For example, a coating film is formed by using a charge transporting layer-forming solution prepared by adding the above-mentioned components to a solvent, dried, and, if needed, heated.

Examples of the solvent used to prepare the charge transporting layer-forming solution include common organic solvents such as aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in combination as a mixture.

Examples of the method for applying the charge transporting layer-forming solution to the charge generating layer include common methods such as a blade coating method, a wire bar coating method, a spray coating method, a dip coating method, a bead coating method, an air knife coating method, and a curtain coating method.

The thickness of the charge transporting layer is preferably set within the range of, for example, 5 μm or more and 50 μm or less, and more preferably within the range of 10 μm or more and 30 μm or less.

### Protective Layer

A protective layer is disposed on a photosensitive layer if necessary. The protective layer is, for example, formed to avoid chemical changes in the photosensitive layer during charging and further improve the mechanical strength of the photosensitive layer.

Thus, the protective layer may be a layer formed of a cured film (crosslinked film). Examples of such a layer include layers indicated in 1) and 2) below.

1) A layer formed of a cured film of a composition that contains a reactive-group-containing charge transporting material having a reactive group and a charge transporting skeleton in the same molecule (in other words, a layer that contains a polymer or crosslinked body of the reactive-group-containing charge transporting material).

2) A layer formed of a cured film of a composition that contains a non-reactive charge transporting material, and a reactive-group-containing non-charge transporting material that does not have a charge transporting skeleton but has a reactive group (in other words, a layer that contains a polymer or crosslinked body of the non-reactive charge transporting material and the reactive-group-containing non-charge transporting material).

Examples of the reactive group contained in the reactive-group-containing charge transporting material include chain-polymerizable groups, an epoxy group, —OH, —OR (where R represents an alkyl group), —NH₂, —SH, —COOH, and —SiR^{Q1}_{3-Qn}(OR^{Q2})_{Qn} (where R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3).

The chain-polymerizable group may be any radical-polymerizable functional group, and an example thereof is a functional group having a group that contains at least a carbon-carbon double bond. A specific example thereof is a group that contains at least one selected from a vinyl group, a vinyl ether group, a vinyl thioether group, a styryl group (vinylphenyl group), an acryloyl group, a methacryloyl group, and derivatives thereof. Among these, the chain-polymerizable group may be a group that contains at least one selected from a vinyl group, a styryl group (vinylphenyl group), an acryloyl group, a methacryloyl group, and derivatives thereof due to their excellent reactivity.

The charge transporting skeleton of the reactive-group-containing charge transporting material may be any known structure used in the electrophotographic photoreceptor, and examples thereof include skeletons that are derived from nitrogen-containing hole transporting compounds, such as triarylamine compounds, benzidine compounds, and hydrazone compounds, and that are conjugated with nitrogen atoms. Among these, a triarylamine skeleton is preferable.

The reactive-group-containing charge transporting material that has such a reactive group and a charge transporting skeleton, the non-reactive charge transporting material, and the reactive-group-containing non-charge transporting material may be selected from among known materials.

The protective layer may contain other known additives.

The protective layer may be formed by any known method. For example, a coating film is formed by using a protective layer-forming solution prepared by adding the above-mentioned components to a solvent, dried, and, if needed, cured such as by heating.

Examples of the solvent used to prepare the protective layer-forming solution include aromatic solvents such as toluene and xylene, ketone solvents such as methyl ethyl ketone, methyl isobutyl ketone, and cyclohexanone, ester solvents such as ethyl acetate and butyl acetate, ether solvents such as tetrahydrofuran and dioxane, cellosolve solvents such as ethylene glycol monomethyl ether, and alcohol solvents such as isopropyl alcohol and butanol. These solvents are used alone or in combination as a mixture.

The protective layer-forming solution may be a solvent-free solution.

Examples of the application method used to apply the protective layer-forming solution onto the photosensitive layer (for example, the charge transporting layer) include common methods such as a dip coating method, a lift coating method, a wire bar coating method, a spray coating method, a blade coating method, a knife coating method, and a curtain coating method.

The thickness of the protective layer is preferably set within the range of, for example, 1 μm or more and 20 μm or less, and more preferably within the range of 2 μm or more and 10 μm or less.

### Single-Layer-Type Photosensitive Layer

The single-layer-type photosensitive layer (charge generating/charge transporting layer) is, for example, a layer that contains a charge generating material, a charge transporting material, and, optionally, a binder resin and other known additives. These materials are the same as those described in relation to the charge generating layer and the charge transporting layer.

The amount of the charge generating material contained in the single-layer-type photosensitive layer relative to the total solid content may be 0.1 mass % or more and 10 mass % or less, and is preferably 0.8 mass % or more and 5 mass % or less. The amount of the charge transporting material contained in the single-layer-type photosensitive layer relative to the total solid content may be 5 mass % or more and 50 mass % or less.

The method for forming the single-layer-type photosensitive layer is the same as the method for forming the charge generating layer and the charge transporting layer.

The thickness of the single-layer-type photosensitive layer may be, for example, 5 μm or more and 50 μm or less, and is preferably 10 μm or more and 40 μm or less. Second transfer member

Next, the second transfer roll 22 and the second transfer belt 23 (hereinafter may be referred as the “second transfer member of this exemplary embodiment”) are described. In the description below, the reference signs are omitted.

The surface (outer peripheral surface) of the second transfer member of this exemplary embodiment has a hexadecane contact angle of 30 degree or more. From the viewpoint of improving the cleanability maintaining property, the angle may be 35 degree or more. However, when the hexadecane contact angle at the surface is excessively large, the cleanability of the second transfer member tends to be degraded; thus, the hexadecane contact angle at the surface may be, for example, 90 degrees or less.

Here, the “hexadecane contact angle at the surface” is a value measured as follows.

A sample is taken from the second transfer member to be measured. Next, in an environment having a temperature of 25° C. and a humidity of 50%, 3 μl of hexadecane (purity: 99%) is dropped onto a measurement surface of the sample (in other words, the surface corresponding to the outer peripheral surface of the second transfer member) by using a contact angle meter (model number: CA-X-FACE produced by Kyowa Interface Science, Inc.), and the droplets 3 seconds after the dropping are imaged by using an optical microscope. The hexadecane contact angle θ is then determined by the θ/2 method from the obtained image.

Examples of the second transfer member that has a hexadecane contact angle satisfying the aforementioned range at the surface include second transfer members of the following first and second exemplary embodiments.

### First Exemplary Embodiment

A second transfer member of the first exemplary embodiment has a surface formed of a resin layer that contains polytetrafluoroethylene particles (PTFE particles) and a dispersant containing fluorine atoms (fluorine-containing dispersant) (hereinafter this resin layer may be referred to as the “PTFE particle-containing resin layer”).

The second transfer member of the first exemplary embodiment may have a single layer structure formed of the PTFE particle-containing resin layer or a multilayer structure that includes two or more layers, outermost layer of which is a PTFE particle-containing resin layer.

An example of the multilayer structure including two or more layers when the second transfer member of the first exemplary embodiment is a second transfer belt is a stacked structure that includes a substrate layer and a PTFE particle-containing resin layer disposed on the substrate layer; and an example of the multilayer structure when the second transfer member is a second transfer roll is a stacked structure that includes a substrate (a shaft or the like), an elastic layer on the substrate, and a PTFE particle-containing resin layer on the elastic layer.

The PTFE particle-containing resin layer will now be described.

Examples of the resin contained in the PTFE particle-containing resin layer include kwon resins such as polyurethane resins, fluorinated polyurethane resins, polyamide resins, fluorinated polyimide resins, polyamide resins, polyamideimide resins, polyetherimide resins, polyether ether ester resins, polyarylate resins, polyester resins, polyether ether ketone resins, polyether sulfone resins, polyphenylsulfone, polysulfone resins, polyethylene terephthalate resins, polybutylene terephthalate resins, polyacetal resins, polycarbonate resins, and acrylic resins.

Among these, from the viewpoint of improving the cleanability maintaining property, the resin may be a polyimide resin, a polyamideimide resin, a polycarbonate resin, or an acrylic resin.

The PTFE particle-containing resin layer may be a resin layer that contains two or more of these resins.

Examples of the PTFE particles contained in the PTFE particle-containing resin layer include PTFE particles contained in the outermost surface layer of the photoreceptor.

The PTFE particle content in the PTFE particle-containing resin layer relative to the resin in the PTFE particle-containing resin layer is preferably 10 mass % or more and 50 mass % or less and more preferably 15 mass % or more and 35 mass % or less.

For example, the type and content of the fluorine-containing dispersant contained in the PTFE particle-containing resin layer are the same as the fluorine-containing dispersant contained in the outermost surface layer of the photoreceptor.

The perfluorooctanoic acid (PFOA) content in the PTFE particle-containing resin layer may be 25 ppb or less relative to the PTFE particles. The PFOA content is the same as in the outermost surface layer of the photoreceptor.

When the PFOA content in the PTFE particle-containing resin layer is within the aforementioned range, as described above, the dispersibility of the PTFE particles is improved, and the PTFE particle-containing resin layer captures the PTFE particles that have migrated from the outermost surface layer of the photoreceptor onto the entire surface of the second transfer member in a substantially uniform manner. Thus, the cleanability maintaining property is easily improved.

The area ratio at which the PTFE particles are exposed in the surface of the PTFE particle-containing resin layer (in other words, the surface of the second transfer member) (hereinafter this area ratio may also be referred to as the “PTFE particle exposed area ratio”) may be set to 20% or more and 80% or less (preferably 30% or more and 70% or less) from the viewpoint of improving the cleanability maintaining property.

When the PTFE particle exposed area ratio is increased to be within the aforementioned range, the exposed PTFE particles on the surface of the second transfer member capture the PTFE particles that have migrated from the outermost surface layer of the photoreceptor, and thus, the cleanability maintaining property can be further improved.

Examples of the method for adjusting the PTFE particle exposed area ratio to be within the aforementioned range include a method involving increasing the PTFE particle content and a method involving causing the PTFE particles to distribute in a high concentration toward the surface of the PTFE particle-containing resin layer (in other words, the surface of the second transfer member).

The PTFE particle exposed area ratio is a value measured by the following method.

A sample is cut out from the second transfer member to be measured, and the F element ratio on the surface of the second transfer member is calculated by using an X-ray photoelectron spectroscope (XPS) (“JPS-9000MX” produced by JEOL Ltd.) to determine the PTFE particle exposed area ratio. Here, the abundance ratio of the F element in the PTFE particles is assumed to be 70%, and the exposed area ratio is calculated by F element ratio (atm %)/0.7.

The PTFE particle-containing resin layer may contain a conductive agent. Other additives may also be contained.

Examples of the conductive agent include carbon black; metals such as aluminum and nickel; metal oxides such as yttrium oxide and tin oxide; ion-conducting substances such as potassium titanate and potassium chloride; and conductive polymers such as polyaniline, polypyrrole, polysulfone, and polyacetylene. Of these, carbon black is preferable from the viewpoints of electrical conductivity and economic efficiency.

Examples of the carbon black include Ketjen black, oil furnace black, channel black, acetylene black, and surface-oxidized carbon black (hereinafter referred to as “surface-treated carbon black”). Of these, surface-treated carbon black is preferable from the viewpoint of electric resistance stability over time.

The surface-treated carbon black is obtained by, for example, attaching carboxyl groups, quinone groups, lactone groups, hydroxyl groups, and the like to the surface.

The amount of the conductive agent added relative to 100 parts by mass of the resin is preferably 10 parts by mass or more and 30 parts by mass or less, and more preferably 13 parts by mass or more and 25 parts by mass or less.

Examples of other additives include known additives such as antioxidants, surfactants, heat-resistant antidegradants, dispersants, various fillers, catalysts, and leveling materials.

### Second Exemplary Embodiment

The second transfer member of the second exemplary embodiment has a surface formed of a resin layer containing a resin and perfluoropolyether (hereinafter may also be referred to as “PFPE”) (this resin layer may be referred to as a “PFPE-containing resin layer” hereinafter).

The second transfer member of the second exemplary embodiment may have a single layer structure formed of the PTFE particle-containing resin layer or a multilayer structure that includes two or more layers, outermost layer of which is the PTFE particle-containing resin layer.

An example of the multilayer structure including two or more layers when the second transfer member of the first exemplary embodiment is a second transfer belt is a stacked structure that includes a substrate layer and a PFPE-containing resin layer disposed on the substrate layer; and an example of the multilayer structure when the second transfer member is a second transfer roll is a stacked structure that includes a substrate (a shaft or the like), an elastic layer on the substrate, and a PFPE-containing resin layer on the elastic layer.

The PFPE-containing resin layer will now be described.

The PFPE-containing resin layer may have a sea-island structure having a sea portion containing the resin and an island portion containing PFPE. In other words, PFPE may constitute domains in the resin.

The resin contained in the PFPE-containing resin layer is a resin other than PFPE. Examples of the resin include known resins such as (meth)acrylic resins, styrene resins, polyester resins, epoxy resins, polyether resins, silicone resins, and polyvinyl butyral resins.

The PFPE-containing resin layer may be a resin layer containing two or more of these resins.

An example of PFPE contained in the PFPE-containing resin layer is a polymer having perfluoroalkylene ether as a constitutional unit. PFPE may be an oligomer. An oligomer is a polymer in which a finite number of monomers (for example, 5 or more and 100 or less) are polymerized.

Examples of the perfluoroalkylene ether serving as the constitutional unit of PFPE include perfluoroalkylene ethers having 1 to 8 carbon atoms (preferably 1 to 3 carbon atoms) (for example, perfluoromethylene ether, perfluoroethylene ether, and perfluoropropylene ether).

PFPE having at least one of a perfluoromethylene ether constitutional unit (—(O—CF₂)—)) and a perfluoroethylene ether constitutional unit (—(O—CF₂—CF₂)—) may be used as the PFPE.

Examples of the commercially available PFPE products include “DEMNUM (produced by Daikin Industries, Ltd.)”, “Krytox (produced by DuPont)”, and “Fomblin (produced by Solvay Solexis, Inc.)”.

Another example of the PFPE is PFPE having a reactive functional group. Examples of the reactive functional group include an oxysilanyl group and a (meth)acryl group.

PFPE having a reactive functional group may be PFPE represented by general formula (A) below or a PFPE represented by general formula (B) below.

PFPE represented by general formula (A)

CH₂═C(—CH₃)—C(═O)—O—CH₂—CF₂—Rf—O—CF₂—CH₂—O—C(═O)—C(—CH₃)═CH₂

PFPE represented by general formula (B)

CH₂═C(—CH₃)—C(═O)—O—(CH₂)₂—NH—C(═O)—O—CH₂—CF₂—Rf—O—CF₂—CH₂—O—C(═O)—NH—(CH₂)₂—O—C(═O)—C(—CH₃)═CH₂

Here, in general formulae (A) and (B), Rf represents at least one of a repeating unit having a perfluoromethylene ether constitutional unit (—(O—CF₂)—)) and a perfluoroethylene ether constitutional unit (—(O—CF₂—CF₂)—).

The repeating number of the perfluoromethylene ether constitutional unit and the repeating number of the perfluoromethylene ether constitutional unit may each independently be 0 or more and 50 or less, or 2 or more and 40 or less. However, the total repeating number of the two constitutional units is 1 or more.

When both of the perfluoromethylene ether constitutional unit and the perfluoroethylene ether constitutional unit are present, these constitutional units may take a random copolymer structure or a block copolymer structure.

Examples of the commercially available products for PFPE having a reactive functional group include “Fluorolink S10” (PFPE having an oxysilanyl group produced by Solvay Solexis, Inc.), “Fluorolink MD500, MD700, 5101X, 5113X, and AD1700” (PFPE containing a (meth)acryl group, produced by Solvay Solexis, Inc.), and “OPTOOL DAC” (PFPE having a (meth)acryl group produced by Daikin Industries, Ltd.).

The number-average molecular weight of the PFPE is preferably 100 or more and 20000 or less and more preferably 380 or more and 20,000 or less.

The number-average molecular weight of the PFPE is measured by gel permeation chromatography (GPC). Specifically, measurement is conducted by using HPLC1100 produced by TOSOH CORPORATION as a measuring instrument with columns, TSKgel GMHHR-M+TSKgel GMHHR-M (7.8 mm I.D., 30 cm) produced by TOSOH CORPORATION, and a tetrahydrofuran (THF) solvent. The number-average molecular weight is calculated from the measurement results by using the molecular weight calibration curves obtained from monodisperse polystyrene standard samples.

The PFPE content relative to the total solid content in the PFPE-containing resin layer is preferably 5.0 mass % or more and 70.0 mass % or less, more preferably 10.0 mass % or more and 60.0 mass % or less, and yet more preferably 20.0 mass % or more and 50.0 mass % or less.

The PFPE-containing resin layer may contain other additives.

Examples of other additives include known additives such as dispersants, conductive agents, fillers, coloring agents, and leveling materials.

From the viewpoint of stabilizing the PFPE domains, the dispersant may be a block copolymer between a vinyl monomer having a fluoroalkyl group and a (meth)acrylate, or a comb graft copolymer between a (meth)acrylate having a fluoroalkyl group and a methacrylate macromonomer having polymethyl methacrylate in a side chain.

Next, layers (substrate layer and elastic layer) other than the PTFE particle-containing resin layer and the PFPE-containing resin layer in the second transfer member of the exemplary embodiment are described.

When the second transfer member of the exemplary embodiment is a second transfer belt, the substrate serving as a layer under the PTFE particle-containing resin layer and the PFPE-containing resin layer may be any, and any substrate layer used in typical second transfer belts is employed.

Examples of the substrate layer include resin layers containing conductive agents (examples of the resin layers include layers of a polyurethane resin, a fluorinated polyurethane resin, a polyimide resin, a fluorinated polyimide resin, a polyamide resin, a polyamideimide resin, a polyetherimide resin, a polyether ether ester resin, a polyarylate resin, a polyester resin, a polyether ether ketone resin, a polyethersulfone resin, a polyphenylsulfone resin, a polysulfone resin, a polyethylene terephthalate resin, a polybutylene terephthalate resin, a polyacetal resin, and a polycarbonate resin) and rubber layers containing conductive agents (examples of the rubber layers include layers of one or any combination of an isoprene rubber, a chloroprene rubber (CR), an epichlorohydrin rubber (ECO), a butyl rubber, polyurethane, a silicone rubber, a fluororubber, a styrene-butadiene rubber, a butadiene rubber, a nitrile rubber, an ethylene propylene rubber, an epichlorohydrin-ethylene oxide copolymer rubber, an epichlorohydrin-ethylene oxide-allyl glycidyl ether copolymer rubber, an ethylene-propylene-diene ternary copolymer rubber (EPDM), an acrylonitrile-butadiene copolymer rubber (NBR), and a natural rubber).

When the second transfer member of the exemplary embodiment is a second transfer roll, the elastic layer serving as a layer under the PTFE particle-containing resin layer and the PFPE-containing resin layer may be any, and any elastic layer used in typical second transfer rolls is employed.

Examples of the elastic layer include rubber layers containing conductive agents (examples of the rubber layers include layers of one or any combination of an isoprene rubber, a chloroprene rubber (CR), an epichlorohydrin rubber (ECO), a butyl rubber, polyurethane, a silicone rubber, a fluororubber, a styrene-butadiene rubber, a butadiene rubber, a nitrile rubber, an ethylene propylene rubber, an epichlorohydrin-ethylene oxide copolymer rubber, an epichlorohydrin-ethylene oxide-allyl glycidyl ether copolymer rubber, an ethylene-propylene-diene ternary copolymer rubber (EPDM), an acrylonitrile-butadiene copolymer rubber (NBR), and a natural rubber). The elastic layer may be a foam layer or non-foam layer.

The second transfer member of this exemplary embodiment is not limited to the second transfer members of the first and second exemplary embodiments described above.

### Examples

Examples of the present disclosure will now be described in further detail, but the present disclosure is not limited by the examples. Unless otherwise noted, “parts” and “%” are on a mass basis.

### Photoreceptor A

### Preparation of PTFE Particles A

Commercially available PTFE particles having an average particle diameter of 3.5 μm (primary particle diameter: 0.2 μm) are washed and then treated with a fluorine-containing dispersant as described below to form PTFE particles A.

Four hundred parts by mass of tetrahydrofuran and 15 parts by mass of the PTFE particles are taken to prepare a mixture, the pressure of a high-pressure homogenizer (trade name: LA-33S produced by NANOMIZER Inc.) is set at 500 kg/cm², and the mixture is passed through the high-pressure homogenizer four times to wash the mixture. After the resulting dispersion is treated in a centrifugal separator, the liquid in the transparent upper layer portion is removed. Next, tetrahydrofuran is added so that the amount of the liquid is 415 parts by mass, and after the resulting mixture is again dispersed in a high-pressure homogenizer, the resulting dispersion is treated in a centrifugal separator, and the liquid in the transparent upper layer portion is removed. After this operation is further repeated three times, as the fluorine-containing dispersant, 1.5 parts of GF400 (produced by Toagosei Co, Ltd., a surfactant in which at least a methacrylate having a fluorinated alkyl group is used as the polymerization component) is added to the resulting mixture, tetrahydrofuran is added so that the amount of the liquid is 415 parts by mass, and after the resulting mixture is again dispersed in a high-pressure homogenizer, the solvent is distilled away at a reduced pressure. Then, the dried particles are pulverized in a mortar. The resulting particles are used as PTFE particles A.

The “PFOA content” of the resulting PTFE particles A is measured according to the aforementioned method, and is found to be 5 ppb.

### Preparation of PTFE Composition L-A

In 350 parts of toluene and 150 parts of tetrahydrofuran, 45 parts of a benzidine compound represented by formula (CT-1) below and 55 parts of a polymer compound (viscosity-average molecular weight: 40,000) having a repeating unit represented by formula (B-1) below are dissolved, 10 parts of the PTFE particles A are added to the resulting solution, and the resulting mixture is treated five times with a high-pressure homogenizer to prepare a PTFE composition L-A.

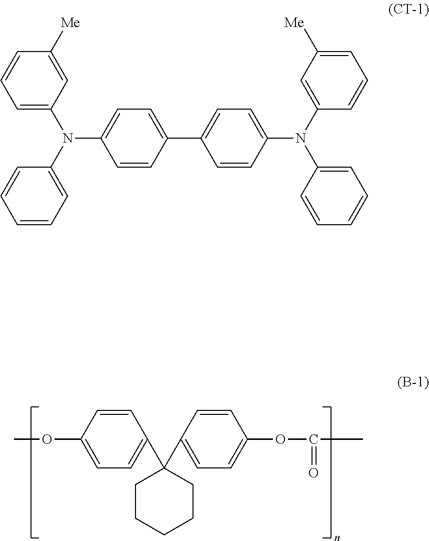

The dispersed state of the PTFE in the obtained PTFE composition L-A is evaluated by using a laser diffraction particle size analyzer (MASTERSIZER 3000: Malvern), and the average particle diameter is found to be 0.22 μm. Preparation of photoreceptor A

A photoreceptor A is prepared as follows.

### Formation of Undercoat Layer

One hundred parts of zinc oxide (average particle diameter: 70 nm, produced by Tayca Corporation, specific surface area: 15 m²/g) is mixed with 500 parts of tetrahydrofuran, and 1.3 parts of a silane coupling agent (KBM503 produced by Shin-Etsu Chemical Co., Ltd.) is added thereto, followed by stirring for 2 hours. Then, tetrahydrofuran is distilled away by vacuum distillation, baking is performed at 120° C. for 3 hours, and, as a result, zinc oxide surface-treated with the silane coupling agent is obtained.

One hundred and ten parts of the surface-treated zinc oxide and 500 parts of tetrahydrofuran are mixed and stirred, a solution prepared by dissolving 0.6 parts of alizarin in 50 parts of tetrahydrofuran is added to the resulting mixture, and the resulting mixture is stirred at 50° C. for 5 hours. Subsequently, alizarin-doped zinc oxide is separated by vacuum filtration and vacuum-dried at 60° C. As a result, alizarin-doped zinc oxide is obtained.

Sixty parts of the alizarin-doped zinc oxide, 13.5 parts of a curing agent (blocked isocyanate, Sumidur 3175 produced by Sumitomo Bayer Urethane Co., Ltd.), 15 parts of a butyral resin (S-LEC BM-1 produced by Sekisui Chemical Co., Ltd.), and 85 parts of methyl ethyl ketone are mixed to obtain a mixed solution. Thirty eight parts of this mixed solution and 25 parts of methyl ethyl ketone are mixed, and the resulting mixture is dispersed for 2 hours in a sand mill using 1 mmϕ glass beads to obtain a dispersion.

To the obtained dispersion, 0.005 parts of dioctyltin dilaurate serving as a catalyst and 45 parts of silicone resin particles (Tospearl 145 produced by Momentive Performance Materials Japan LLC) are added to obtain an undercoat layer-forming solution. The solution is applied to an aluminum substrate having a diameter of 47 mm, a length of 357 mm, and a thickness of 1 mm by a dip coating method, and dried and cured at 170° C. for 30 minutes, so as to obtain an undercoat layer having a thickness of 25 μm. Formation of charge generating layer

Next, 1 part of hydroxygallium phthalocyanine having intense diffraction peaks at Bragg's angles (2θ±0.2°) of 7.5°, 9.9°, 12.5°, 16.3°, 18.6°, 25.1°, and 28.3° in an X-ray diffraction spectrum, 1 part of polyvinyl butyral (S-LEC BM-S produced by Sekisui Chemical Co., Ltd.), and 80 parts of n-butyl acetate are mixed, and the resulting mixture is dispersed with glass beads in a paint shaker for 1 hour to prepare a charge generating layer-forming solution. The obtained solution is applied to the undercoat layer on the conductive support by dip-coating, and heated at 100° C. for 10 minutes to form a charge generating layer having a thickness of 0.15 μm.

### Formation of Charge Transporting Layer

The PTFE composition A is applied to the charge generating layer by dip-coating, and heated at 130° C. for 45 minutes to prepare a charge transporting layer having a thickness of 13 μm.

The “PFOA content” of the charge transporting layer is measured according to the aforementioned method, and is found to be 5 ppb. The average particle diameter of the PTFE particles in the charge transporting layer is 0.23 μm.

A photoreceptor A is prepared through the steps described above.

### Photoreceptor B

### Preparation of PTFE Particles B

Commercially available PTFE particles having an average particle diameter of 4.5 μm (primary particle diameter: 0.2 μm) are washed and treated with a fluorine-containing dispersant as with the PTFE particles A so as to form PTFE particles B.

The “PFOA content” of the obtained PTFE particles B is measured according to the aforementioned method, and is found to be 0 ppb.

### Preparation of PTFE Composition L-B

A PTFE composition L-B is prepared by performing the same process as that for the PTFE composition L-A except that the PTFE particles A are changed to PTFE particles B.

The dispersed state of the PTFE in the obtained PTFE composition L-B is evaluated by using a laser diffraction particle size analyzer (MASTERSIZER 3000: Malvern), and the average particle diameter is found to be 0.21 μm.

### Preparation of Photoreceptor B

A photoreceptor B is prepared by performing the same process as that for the photoreceptor A except that the PTFE composition L-A is changed to the PTFE composition L-B.

The “PFOA content” of the charge transporting layer is measured according to the aforementioned method, and is found to be 0 ppb. The average particle diameter of the PTFE particles in the charge transporting layer is 0.22 μm.

### Photoreceptor C

PTFE particles C are prepared by washing and treating with a fluorine-containing dispersant as with the PTFE particles A except the total PFOA content is adjusted to 25 ppb.

### Preparation of PTFE Composition L-C

A PTFE composition L-C is prepared by performing the same process as that for the PTFE composition L-A except that the PTFE particles A are changed to PTFE particles C.

The dispersed state of the PTFE in the obtained PTFE composition L-C is evaluated by using a laser diffraction particle size analyzer (MASTERSIZER 3000: Malvern), and the average particle diameter is found to be 0.22 μm.

### Preparation of Photoreceptor C

A photoreceptor C is prepared by performing the same process as that for the photoreceptor A except that the PTFE composition L-A is changed to the PTFE composition L-C.

The “PFOA content” of the charge transporting layer is measured according to the aforementioned method, and is found to be 25 ppb. The average particle diameter of the PTFE particles in the charge transporting layer is 0.24 μm.

### Comparative Photoreceptor D

PTFE particles D are prepared by washing and treating with a fluorine-containing dispersant as with the PTFE particles A except the total PFOA content is adjusted to 30 ppb.

### Preparation of PTFE Composition L-D

A PTFE composition L-D is prepared by performing the same process as that for the PTFE composition L-A except that the PTFE particles A are changed to PTFE particles D.

The dispersed state of the PTFE in the obtained PTFE composition L-D is evaluated by using a laser diffraction particle size analyzer (MASTERSIZER 3000: Malvern), and the average particle diameter is found to be 0.25 μm.

### Preparation of Comparative Photoreceptor D

A comparative photoreceptor D is prepared by performing the same process as that for the photoreceptor A except that the PTFE composition L-A is changed to the PTFE composition L-D.

The “PFOA content” of the charge transporting layer is measured according to the aforementioned method, and is found to be 30 ppb. The average particle diameter of the PTFE particles in the charge transporting layer is 0.35 μm.

### Second Transfer Belt A

A second transfer belt A is prepared as follows.

### Preparation of Substrate Rubber

A rubber composition is prepared by blending the components at rubber blend ratio described below.

### Rubber Blend 1

EPDM: (ethylene propylene diene rubber, EP33 produced by JSR Corporation) 35 parts

CR: (chloroprene rubber, TSR-61 produced by TOSOH CORPORATION) 35 parts

ECO: (epichlorohydrin rubber, 610 produced by DAISO CO., LTD.) 15 parts

NBR: (nitrile butadiene rubber, DN211 produced by ZEON CORPORATION) 15 parts

Electron conducting material: CB (carbon black, #3030B produced by Mitsubishi Chemical Corporation) 23 parts

Sulfur: (produced by Tsurumi Chemical Industry Co., Ltd.) 0.5 parts

ZnO: (produced by Kyoudou Kagaku Kougyou Co. Ltd.) 5 parts

Vulcanization promotor: (NOCCELER M produced by OUCHI SHINKO CHEMICAL INDUSTRIAL CO., LTD.) 1 part

Stearic Acid: 0.5 Parts

The composition having the aforementioned rubber blend is placed in a Banbury mixer and kneaded, and the resulting rubber composition is kneaded with two rolls. The obtained kneaded mixture is formed into an endless belt by using a tubular cross head extrusion molding machine.

Next, the rubber composition formed into an endless belt is heated in a vulcanization can with pressurized steam (temperature: 126° C., pressure: 1.5 kg/cm²) so as to vulcanize and form a substrate rubber. The obtained substrate rubber is placed on the outer side of a metal tube, and the surface is polished to prepare a substrate rubber layer (diameter: 40 mm, width: 340 mm, thickness: 492 μm) having an endless belt shape.

### Preparation of Surface Layer

### Formation of Surface Layer

Dipentaerythritol hexaacrylate: 10 parts by mass
Pentaerythritol tetraacrylate: 20 parts by mass
Methyl ethyl ketone: 45 parts by mass
Ethylene glycol: 15 parts by mass
Antimony-doped zinc oxide fine particles: 5.0 parts by mass
Polymerization initiator (IRGACURE 184 produced by BASF): 4.0 parts by mass
Dispersant (GF-400 produced by Toagosei Co, Ltd.): 20 parts by mass
PFPE (MD700 produced by Solvay Solexis, Inc.): 7.0 parts by mass

The above-described materials are mixed in a homogenizer to obtain a surface layer coating solution. The coating solution is spray-coated on the substrate rubber layer to form a coating film, and the coating film is dried at 70° C. for 3 minutes and then irradiated with UV light for 6 minutes from an irradiation distance of 100 mm using a high-pressure mercury lamp (H04-L41 produced by Eye Graphics Co., Ltd.) so as to form a surface layer having a thickness of 5 μm.

A second transfer belt A is obtained through the aforementioned steps.

The “hexadecane contact angle” at the surface (outer peripheral surface) of the second transfer belt B is measured by the aforementioned method, and is found to be 30 degrees.

### Second Transfer Belt B

A second transfer belt B is obtained by using the substrate rubber layer of the second transfer belt A as the substrate and by applying a fluorine-based lubricant, HANARL (produced by KANTO KASEI CO., LTD.), to the belt surface.

The “hexadecane contact angle” at the surface (outer peripheral surface) of the second transfer belt B is measured by the aforementioned method, and is found to be 60 degrees.

### Second Transfer Belt C

### Preparation of Surface Layer

### Formation of Surface Layer

Into a polyamic acid N-methyl-2-pyrrolidone (NMP) solution (U Imide KX produced by UNITIKA LTD., solid matter concentration: 20 mass %) containing biphenyltetracarboxylic dianhydride (BPDA) and p-phenylenediamine (PDA), 20 mass % or more and 30 mass % or less of carbon black (SPECIAL Black 4, Evonik Japan Co., Ltd.) in terms of a solid mass ratio is injected, 33 mass % of the PTFE particles D are added thereto, and the resulting mixture is dispersed (200 N/mm², 5 passes) by using a jet mill disperser (Geanus PY produced by Geanus Co.). The resulting mixed solution is passed through a stainless steel 20 μm mesh to remove foreign matter and carbon black agglomerates. The solution is degassed under vacuum for 15 minutes while being stirred so as to prepare a PTFE-mixed PI resin precursor solution.

Next, the PTFE-mixed PI resin precursor solution is applied to the substrate rubber layer of the second transfer belt A by a spiral coating method so as to form a coating film, and the coating film is dried at 90° C. for 30 minutes and then heated at 320° C. for 2 hours to form a surface layer having a thickness of 15 μm.

A second transfer belt C is obtained through the aforementioned steps.

The “hexadecane contact angle” at the surface (outer peripheral surface) of the second transfer belt C is measured by the aforementioned method, and is found to be 40 degrees.

### Second Transfer Belt D

A second transfer belt D is obtained as with the second transfer belt C except that the PTFE particles to be added to the PTFE-mixed PI resin precursor solution for forming the surface layer are changed to PTFE particles A, and the amount thereof added is changed to 33 parts by mass.

The “hexadecane contact angle” at the surface (outer peripheral surface) of the second transfer belt D is measured by the aforementioned method, and is found to be 40 degrees.

### Second Transfer Belt E

A second transfer belt E is obtained as with the second transfer belt C except that the PTFE particles to be added to the PTFE-mixed PI resin precursor solution for forming the surface layer are changed to PTFE particles A, and the amount thereof added is changed to 50 parts by mass.

The “hexadecane contact angle” at the surface (outer peripheral surface) of the second transfer belt E is measured by the aforementioned method, and is found to be 60 degrees.

### Second Transfer Belt F

A second transfer belt F is obtained as with the second transfer belt C except that the PTFE particles to be added to the PTFE-mixed PI resin precursor solution for forming the surface layer are changed to PTFE particles A, and the amount thereof added is changed to 10 parts by mass.

The “hexadecane contact angle” at the surface (outer peripheral surface) of the second transfer belt F is measured by the aforementioned method, and is found to be 35 degrees.

### Second Transfer Belt G

A second transfer belt G is obtained as with the second transfer belt C except that the PTFE particles to be added to the PTFE-mixed PI resin precursor solution for forming the surface layer are changed to PTFE particles A, and the amount thereof added is changed to 8 parts by mass.

The “hexadecane contact angle” at the surface (outer peripheral surface) of the second transfer belt G is measured by the aforementioned method, and is found to be 30 degrees.

### Second Transfer Roll H

A second transfer roll H is prepared as follows.

A roll-shaped urethan layer is formed by polymerizing an isocyanate and a polyol on a metal shaft having a diameter of ϕ6 mm, and is vulcanized and foamed by heating to form a urethane foam layer having a diameter of ϕ23 mm serving as an ion-conducting roll. Benzenesulfonyl hydrazide is used as a blowing agent. Subsequently, the outer peripheral surface of the urethane foam layer is polished to prepare a transfer roll substrate having a diameter of ϕ20.5 mm at both end portions and an axis direction length of the elastic layer: 340.6 mm.

A surface layer having a thickness of 5 μm is formed on the prepared transfer roll substrate as with the second transfer belt A.

A second transfer roll H is obtained through the aforementioned steps.

The “hexadecane contact angle” at the surface (outer peripheral surface) of the second transfer roll H is measured by the aforementioned method, and is found to be 30 degrees.

### Comparative Second Transfer Belt I

A comparative second transfer belt I is obtained as with the second transfer belt C except that the PTFE particles to be added to the PTFE-mixed PI resin precursor solution for forming the surface layer are changed to PTFE particles A, and the amount thereof added is changed to 4 parts by mass.

The “hexadecane contact angle” at the surface (outer peripheral surface) of the comparative second transfer belt I is measured by the aforementioned method, and is found to be 10 degrees.

### Examples 1 to 8 and Comparative Examples 1 to 3

The obtained photoreceptors and second transfer belts are each loaded to an image forming apparatus (modified model of ApeosPort-VII C7773 produced by Fuji Xerox Co., Ltd.) according to combinations indicated in Table.

However, for the second transfer rolls, the apparatus used is an image forming apparatus, ApeosPort-VII C7773 produced by Fuji Xerox Co., Ltd.

These image forming apparatuses are designated as image forming apparatuses of Examples 1 to 8 and Comparative Examples 1 to 3.

### Evaluation

The image forming apparatuses of Examples 1 to 8 and Comparative Examples 1 to 3 are used to perform image forming evaluation (1) and (2). The results are indicated in Table.

### Image Forming Evaluation

Image forming evaluation (1) is performed as follows. A 30% halftone image is output on 5000 sheets of A4 paper by using the apparatuses of the respective examples. The image on the 5000th sheet is observed, and streak-like image defects caused by cleaning failure of the second transfer member are evaluated. The evaluation standard is as follows:

G0: No streak-like image defects are found.

G1: Very slight streak-like image defects not recognizable with naked eye are found (acceptable).

G2: Slight streak-like image defects barely recognizable with naked eye are found (acceptable).

G3: Streak-like image defects recognizable with naked eye are found (unacceptable).

G4: Multiple streak-like image defects recognizable with naked eye are found (unacceptable).

G5: Streak-like image defects recognizable with naked eye are found in throughout the surface (unacceptable).

### Image Forming Evaluation (2)

Image forming evaluation (2) is performed as follows.

A 30% halftone image is output on 200000 sheets of A4 paper by using the apparatuses of the respective examples. Then, the state of the turning-up of the cleaning blade of the second transfer member is investigated.

Examples and Comparative Examples are summarized in Table.

TABLE

| | Photoreceptor | | | | Second transfer member | | | | | |
|---|---|---|---|---|---|---|---|---|---|---|
| | | Charge transporting layer (outermost | | | | | | PTFE | | |
| | | surface layer) | | | | | | particles | | |
| | | PFOA | Average particle diameter of | | | Hexadecane | PFOA | exposed | Streak-like | |
| | | content | PTFE particles (μm) | | | contact angle | content | area ratio | image | Turning-up |
| | No. | (ppb) | In PTFE composition | In layer | No. | (degree) | (ppb) | (%) | defects | of blade |
| Example 1 | A | 5 | 0.22 | 0.23 | A | 30 | — | — | G0 | Absent |
| Example 2 | B | 0 | 0.21 | 0.22 | B | 60 | — | — | G0 | Absent |
| Example 3 | C | 25 | 0.22 | 0.24 | C | 40 | 30 | 60 | G2 | Absent |
| Example 4 | A | 5 | 0.22 | 0.23 | D | 40 | 5 | 60 | G0 | Absent |
| Example 5 | A | 5 | 0.22 | 0.23 | E | 60 | 5 | 80 | G0 | Absent |
| Example 6 | A | 5 | 0.22 | 0.23 | F | 35 | 5 | 30 | G0 | Absent |
| Example 7 | A | 5 | 0.22 | 0.23 | G | 30 | 5 | 20 | G1 | Absent |
| Example 8 | A | 5 | 0.22 | 0.23 | H | 30 | — | — | G0 | Absent |
| Comparative | A | 5 | 0.22 | 0.23 | I | 10 | 5 | 15 | G5 | Present |
| Example 1 | | | | | | | | | | |
| Comparative | D | 30 | 0.25 | 0.35 | A | 30 | — | — | G4 | Present |
| Example 2 | | | | | | | | | | |
| Comparative | D | 30 | 0.25 | 0.35 | H | 30 | — | — | G4 | Present |
| Example 3 | | | | | | | | | | |

The results indicate that, compared to the image forming apparatuses of the comparative examples, the image forming apparatuses of the examples have less streak-like image defects and less turning-up of the cleaning blade of the second transfer member.

The results indicate that the image forming apparatus of the examples have an excellent second transfer member cleanability maintaining property.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1.-3. (canceled)

4. An image forming apparatus comprising:
a toner image forming device that includes a photoreceptor,
wherein the photoreceptor has an outermost surface layer that contains polytetrafluoroethylene particles and a dispersant containing fluorine atoms and has a perfluorooctanoic acid content of 25 ppb or less relative to the polytetrafluoroethylene particles; and
a transfer device comprising:
an intermediate transfer body having a surface;
a first transfer device configured to perform a first transfer comprising transferring a toner image on the surface of the photoreceptor onto the surface of the intermediate transfer body; and
a second transfer device configured to perform a second transfer comprising transferring the toner image on the surface of the intermediate transfer body onto a surface of a recording medium, the second transfer device having a second transfer member having a surface with a hexadecane contact angle of 30 degrees or more,
wherein the surface of the second transfer member is formed of a resin layer containing polytetrafluoroethylene particles and a dispersant containing fluorine atoms, and
wherein an area ratio at which the polytetrafluoroethylene particles are exposed in the surface of the second transfer member is 20% or more and 80% or less.

5. (canceled)

6. An image forming apparatus comprising:
a toner image forming device that includes a photoreceptor,
wherein the photoreceptor has an outermost surface layer that contains polytetrafluoroethylene particles and a dispersant containing fluorine atoms and has a perfluorooctanoic acid content of 25 ppb or less relative to the polytetrafluoroethylene particles; and
a transfer device comprising:
an intermediate transfer body having a surface;
a first transfer device configured to perform a first transfer comprising transferring a toner image on the surface of the photoreceptor onto the surface of the intermediate transfer body; and
a second transfer device configured to perform a second transfer comprising transferring the toner image on the surface of the intermediate transfer body onto a surface of a recording medium, the second transfer device having a second transfer member having a surface with a hexadecane contact angle of 30 degrees or more,
wherein the polytetrafluoroethylene particles contained in the outermost surface layer of the photoreceptor have an average particle diameter of 0.2 μm or more and 4.5 μm or less.

7. An image forming apparatus comprising:
a toner image forming device that includes a photoreceptor,
wherein the photoreceptor has an outermost surface layer that contains polytetrafluoroethylene particles and a dispersant containing fluorine atoms and has a perfluorooctanoic acid content of 25 ppb or less relative to the polytetrafluoroethylene particles; and
a transfer device comprising:
an intermediate transfer body having a surface;
a first transfer device configured to perform a first transfer comprising transferring a toner image on the surface of the photoreceptor onto the surface of the intermediate transfer body; and
a second transfer device configured to perform a second transfer comprising transferring the toner image on the surface of the intermediate transfer body onto a surface of a recording medium, the second transfer device having a second transfer member having a surface with a hexadecane contact angle of 30 degrees or more,
wherein the dispersant containing fluorine atoms and contained in the outermost surface layer of the photoreceptor is a polymer obtained by homopolymerization or copolymerization of a polymerizable compound having a fluorinated alkyl group.

8. The image forming apparatus according to claim 7, wherein the polymer obtained by homopolymerization or copolymerization of a polymerizable compound having a fluorinated alkyl group is a fluorinated alkyl group-containing polymer having a structural unit represented by general formula (FA) below or a fluorinated alkyl group-containing polymer having a structural unit represented by general formula (FA) below and a structural unit represented by general formula (FB) below: 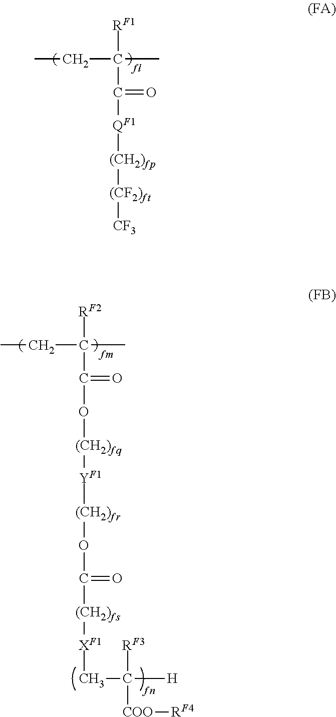
in general formulae (FA) and (FB), R^{F1}, R^{F2}, R^{F3}, and R^{F4} each independently represent a hydrogen atom or an alkyl group, X^{F1} represents an alkylene chain, a halogen-substituted alkylene chain, —S—, —O—, —NH—, or a single bond, Y^{F1} represents an alkylene chain, a halogen-substituted alkylene chain, —(C_{fx}H_{2fx-1}(OH))—, or a single bond, Q^{F1} represents —O— or —NH—, fl, fm, and fn each independently represent an integer of 1 or more, fp, fq, fr, and fs each independently represent 0 or an integer of 1 or more, ft represents an integer of 1 or more and 7 or less, and fx represents an integer of 1 or more.

9. A process cartridge detachably attachable to an image forming apparatus, the process cartridge comprising:
a toner image forming device that includes a photoreceptor,
wherein the photoreceptor has an outermost surface layer that contains polytetrafluoroethylene particles and a dispersant containing fluorine atoms and has a perfluorooctanoic acid content of 25 ppb or less relative to the polytetrafluoroethylene particles; and
a transfer device comprising:
an intermediate transfer body;
a first transfer device configured to perform a first comprising transferring a toner image on the surface of the photoreceptor onto the surface of the intermediate transfer body; and
a second transfer device configured to perform a second transfer comprising transferring the toner image on the surface of the intermediate transfer body onto a surface of a recording medium, the second transfer device having a second transfer member having a surface with a hexadecane contact angle of 30 degrees or more,
wherein the surface of the second transfer member is formed of a resin layer containing polytetrafluoroethylene particles and a dispersant containing fluorine atoms, and
wherein an area ratio at which the polytetrafluoroethylene particles are exposed in the surface of the second transfer member is 20% or more and 80% or less.
